(19) United States
(12) Patent Application Publication
(10) Pub. No.: US 2002/0035607 A1
(43) Pub. Date: Mar. 21, 2002

(54) E-mail gateway system

(76) Inventors: Daniel Checkoway, Newport Beach, CA (US); Neal Checkoway, Ajijic (MX)

Correspondence Address: Christopher J. Rourk, Akin, Gump, Strauss, Hauer & Feld, L.L.P., Suite 4100, 1700 Pacific Avenue, Dallas, TX, 75201-4675, US

(21) Appl. No.: 09/863,556

(22) Filed: May 23, 2001

Related U.S. Application Data
(63) Continuation-in-part of application No. 09/749,323, filed on Dec. 27, 2000.
(60) Provisional application No. 60/211,345, filed on Jun. 13, 2000.
(60) Provisional application No. 60/207,895, filed on May 25, 2000.

(51) Int. Cl. G06F 15/16

(52) U.S. Cl. 709/206; 709/218

(57) ABSTRACT

An e-mail access gateway system is provided. The email access gateway system includes an authorization system that receives an e-mail message and determines whether a reply to the e-mail message is authorized. A reply system coupled to the authorization system receives the e-mail message and generates a response message if the e-mail message is authorized.

### CROSS REFERENCE TO RELATED APPLICATION

This application is a continuation-in-part application of U.S. patent application Ser. No. 09/749,323, filed on Dec. 27, 2000, entitled “E-MAIL ANSWERING AGENT,” and claims priority to U.S. provisional application 60/207,895, filed May 25, 2000, entitled “SYSTEM FOR INTERPRETING AND ANSWERING E-MAIL-, WEB-, AND OTHER NETWORK-BASED QUERIES,” and U.S. provisional application 60/211,345, filed Jun. 13, 2000, entitled “SYSTEM FOR INTERPRETING AND ANSWERING E-MAIL-, WEB-, AND OTHER NETWORK-BASED QUERIES,” each of which are incorporated by reference for all purposes.

### BACKGROUND OF THE INVENTION

1. Technical Field

The present invention relates to information systems, and more specifically to systems and methods for accessing data and functions that permit an ordinary e-mail client to be used as the interface.

2. Description of the Prior Art

Many software applications are configured to operate in a client-server environment, where the primary users of the applications access a server software system for the application over a communications medium, such as a network, using a client software system. The server software system operates on a server processing platform that is configured to provide dedicated support for the server software application, whereas the client software system operates on a client processing platform that might not be configured to provide dedicated support for any particular application.

The client-server operating environment offers many advantages, but one disadvantage is that the client processing platforms must have the client software systems in order to interface with the server software systems. To resolve this problem, many software applications have been adapted to be compatible with web browser access, as a web browser is a fairly common software application that can be found on client processing platforms. While web browser access to server applications has simplified the software requirements for many client processing platforms, there are still many devices that are unable to host a full-featured web browser. These devices, such as Internet-enabled wireless Personal Digital Assistants (PDAs) and wireless phones, are much easier to carry around than a laptop computer or other processing platform, but are incapable of providing web browser support that will allow full-featured access to server-based applications. Therefore, it is still necessary to provide specialized software systems for such devices to allow them to access such server-based applications. In many situations, such specialized software applications are difficult to install on the user's device, are difficult to distribute, or may be incompatible with the user's wireless services provider.

### SUMMARY OF THE INVENTION

In accordance with the present invention, an email gateway system and method of operation are provided that overcome known problems with providing remote access to systems.

In particular, an email gateway system and method of operation are provided that allow users with access to an email client or other email systems to access data and functions of other remote systems without requiring the user to have a web browser, thin client, access system, or other systems that may be required to access all features and data of the remote system.

In accordance with an exemplary embodiment of the present invention, an e-mail access gateway system is provided. The email access gateway system includes an authorization system that receives an e-mail message and determines whether a reply to the e-mail message is authorized. A reply system coupled to the authorization system receives the e-mail message and generates a response message if the e-mail message is authorized.

The present invention provides many important technical advantages. One important technical advantage of the present invention is an email gateway system and method of operation that allow a user to access remote systems using email messaging, without requiring that user to operate a thin client, web browser, or other local interface systems. The present invention thus allows a user to access email servers, contacts databases, calendar databases, proprietary information such as movie listings and showtimes, and other suitable data without requiring the user to have a web browser or other software applications that might otherwise be required for access to all of the features of such remote systems. The present invention also allows a user to access functions of such remote systems, such as to add or delete contacts or calendar entries or purchase movie tickets.

Those skilled in the art will further appreciate the advantages and superior features of the invention together with other important aspects thereof on reading the detailed description that follows in conjunction with the drawings.

### BRIEF DESCRIPTION OF THE SEVERAL VIEWS OF THE DRAWINGS

FIG. 1 is a functional block diagram of an e-mail answering agent embodiment of the present invention;

FIG. 2 is a functional block diagram of an e-mail, HTTP, and WAP answering agent embodiment of the present invention;

FIGS. 3A through 3C are flowcharts describing a scheduler embodiment of the present invention as can be used in FIGS. 1 and 2;

FIG. 4 is a flowchart describing a scheduler embodiment of the present invention as can be used in FIGS. 1 and 2;

FIGS. 5A-5E are flowcharts describing a receiver embodiment of the present invention as can be used in FIGS. 1 and 2;

FIGS. 6A and 6B are flowcharts that represent a topic server embodiment of the present invention as can be used in FIGS. 1 and 2;

FIG. 7 is a diagram representing a way to organize database embodiments of the present invention;

FIG. 8 is a diagram of a system for providing an e-mail access gateway in accordance with an exemplary embodiment of the present invention;

FIG. 9 is a flow chart of a method for providing access to data system functions by e-mail in accordance with an exemplary embodiment of the present invention;

FIG. 10 is a flow chart of a method for adding or modifying records in accordance with exemplary embodiment of the present invention;

FIG. 11 is a flow chart of a method for accessing movie data and purchasing tickets in accordance with an exemplary embodiment of the present invention; and

FIG. 12 is a flowchart of a method that allows a user of e-mail to access a database or functions in accordance with an exemplary embodiment of the present invention.

### DETAILED DESCRIPTION OF THE INVENTION

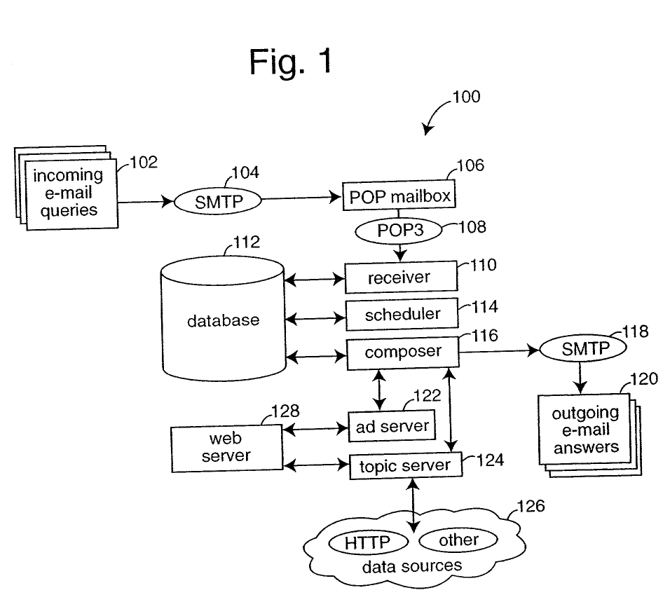

FIG. 1 represents an e-mail answering agent embodiment of the present invention, and is referred to herein by the general reference numeral 100. The answering agent 100 comprises a system for answering informational queries included in an incoming e-mail message 102. A simple mail transfer protocol (SMTP) network 104 is used to deliver these to a post-office protocol (POP) mailbox 106. From there, a POP3 system 108 is used to distribute the queries to a receiver 110. The key information is parsed and saved in a database 112 for processing. The receiver determines if the response should be plain text or can be HTTP, depending on the e-mail application detected. A scheduler 114 decides when each inquiry can be processed and forwards the query to a composer 116. An answer is formulated as an e-mail message that is sent out on an SMTP system 118. A discrete e-mail message 120 with a responsive answer in the message body is sent back to the corresponding user.

Each answer can have an advertisement included by an ad server 122. In a business model embodiment of the present invention, advertisers pay a fee to a service provider to deliver ads to the users along with the answers to the queries. The answers themselves are obtained from the Web by a topic server 124. In one embodiment, the Web is used as a real-time reference library of facts. A group of data sources 126 includes HTTP and other kinds of documents on the Internet and in local databases. A webserver 128 is used to mine data from the data sources 126.

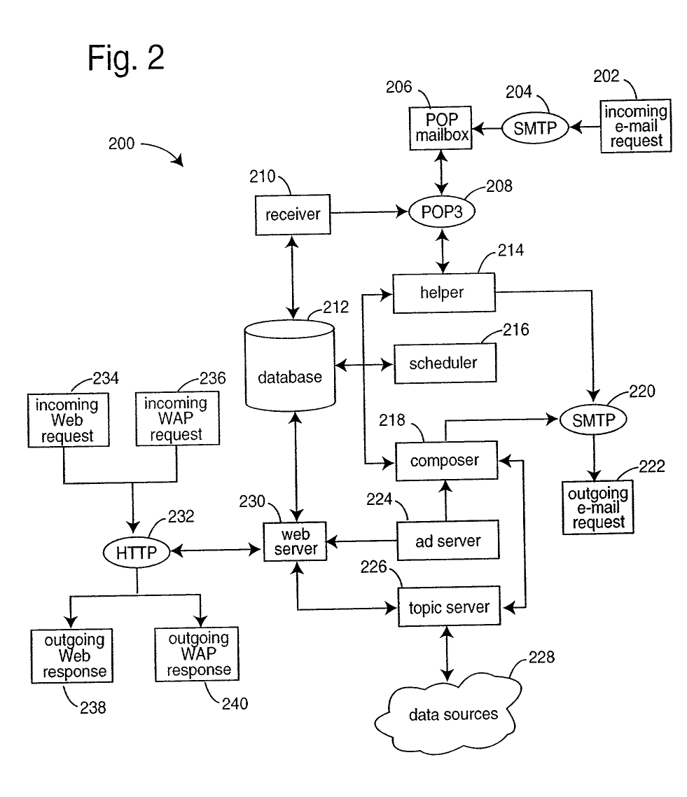

FIG. 2 represents a second e-mail answering agent embodiment of the present invention, and is referred to herein by the general reference numeral 200. The answering agent 200 can answer queries from SMTP e-mail, TCP/IP Internet, and wireless access protocol (WAP). An incoming e-mail request 202 is carried by an SMTP system 204 to a POP-mailbox 206. A POP3 server 208 is connected to a receiver 210. A database 212 holds queries in a queue waiting for service. A helper 214 helps move topics and qualifiers around that have been parsed from incoming messages. A scheduler 216 picks up the next job in the database queue for work by a composer 218. An SMTP server 220 handles outgoing traffic in the form of outgoing e-mail messages 222. An ad server 224 adds commercial paid advertisements to the outgoing answers and responses in a business model embodiment. A plurality of topic servers 226 are each specialized to research particular topics from a variety of data sources 228. A webserver 230 allows an Internet presence that can send and receive HTTP messages 232. Incoming jobs can be received from a web request 234 and also a WAP request 236. The composer 218 sends answers to questions received from the Web and WAP via an outgoing Web response 238 and a WAP response 240.

The way a topic server 226 derives information varies from topic to topic, and is typically a six-step process. A first step dispatches requests to one of several built-in topic “modules” each appointed to handle one discrete topic, e.g., flight status, airfare, area code, movies, dictionary, etc. A second step parses and validates the query parameters. Each particular topic module knows exactly what kind of input it needs. In the case of flight status, an airline and a flight number are expected. In the case of travel directions, a starting and an ending address are necessary. These parameters are dissected using complex, flexible interpretations. For example, the entry of a physical address has seemingly infinite variations, all of which the system 100 and 200 must be able to interpret successfully. A third step starts with a webpage or other given data source and the parameters. It constructs a URL and the posted variables.

For example, once a physical address has been parsed from the query parameters, variables such as “addr=836+Green+Street&city=San+Francisco&state=CA” may be appended to a standard URL. A fourth step fetches/posts to the URL and reads a resulting HTML page, e.g., over a standard HTTP connection with the data source's web site. A step five crops the resulting “raw” HTML to the bare essential information. Typically, there is only a very small section of the resulting web page that is useful to the user. The rest consists of navigation links, advertising, and general aesthetic layout. Only the raw results are needed, so the rest is stripped off.

A sixth and last step parses the HTML and reformats the results depending on the requested output format. Such is a complex process that must usually be custom built for each discrete topic that uses a web site as its data source. Not every HTML page looks the same, so each topic module must “know” the format of its respective data source. When the response comes back, the topic module must interpret the HTML, like a browser, to present it to the user in a meaningful way. For example, if the requested output format is text, and the HTML results contains a table of information, the table tags must be parsed so that the rows and columns of information can be logically redisplayed in plain text. There is a generalized method for doing this that is shared among many topic modules, although no two are purely identical. For example, the HTML “<!TD>” tag signifies the end of a column, which aids in separating informational tokens. The “</TR>” tag signifies the end of a row in a table, and indicates a logical place to put a line break.

In an example of the operation of one embodiment of the present invention, a user wants to know what time a particular airline flight is supposed to land. The user sends an e-mail message to “flightstatus@ halibot.com” and includes the airline and flight number in the subject field, for example,

From: user@somewhere.net
To: flightstatus@halibot.com
Subject: United 2507

When the message arrives in POP mailbox 206 on halibot.com, the receiver 210 detects the new request. It parses out the topic based on the address to which the message was sent and the request parameters from the subject. It also determines the most appropriate output format based on the e-mail application used to compose and send the message. It then queues-up a new request in the database 212. The composer 218 constantly polls the database 212 to detect any queued requests. It connects to the topic server 226 and conveys the topic name, parameters, and output format. The composer 218 takes any results returned from the topic server 226 and sends a message back to the user, for example,

From: flightstatus@halibot.com
To: user@somewhere.net
Subject: Re: United 2507
Flight information last updated less than 1 minute ago.
United Airlines 2507
Departing San Francisco Intl, CA
5:38pm
In Flight
329 mi SW of Chicago, IL
33000′
475 mph
B744
Arriving Newark Intl, NJ
1:11am

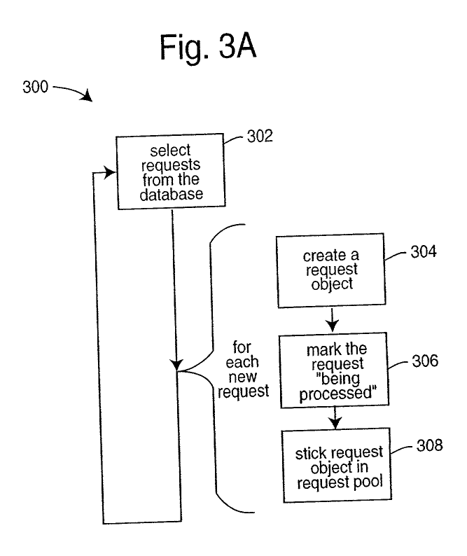

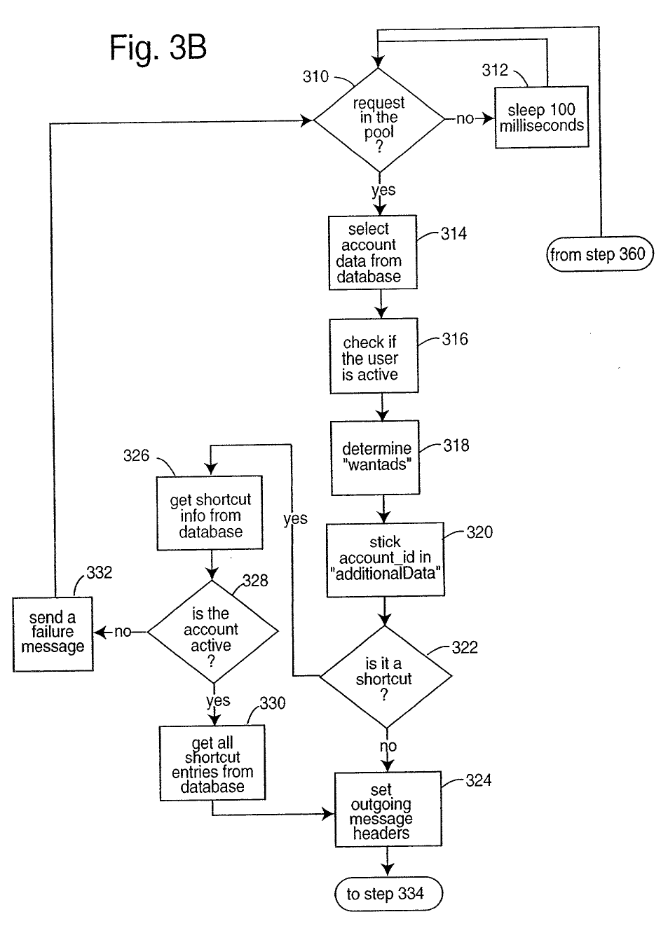

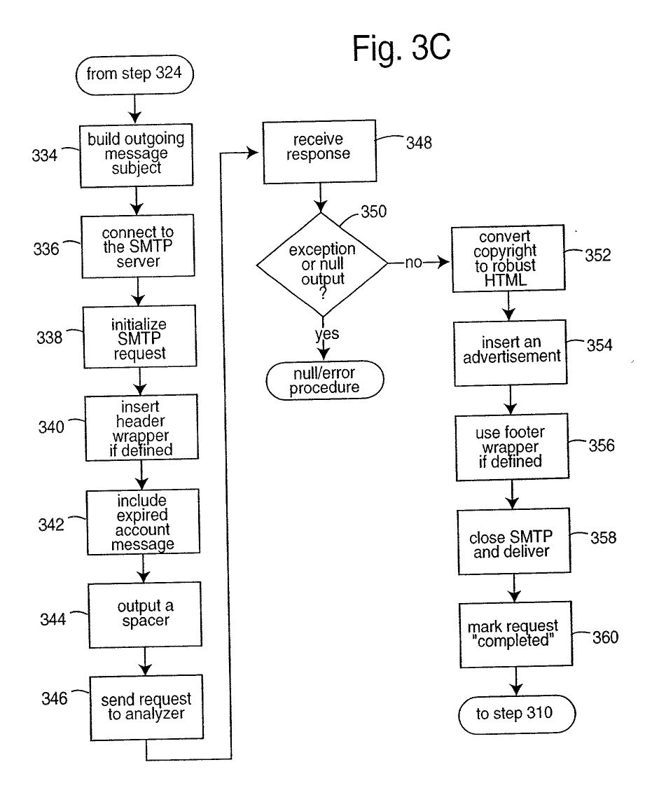

FIG. 3A represents a composer main loop 300. A process 302 selects queued requests from the database. In each iteration of the main loop, the composer 116 and 218 examines a “mail_queue” database table to see if there are any requests that need to be processed. A “fresh” request is identified when a “being_processed_by” column is null, a “began_processing” column is null, and a “completed” column is null. All requests that conform to these criteria are selected by an SQL statement. Such sorts first by priority, and then by the time at which the request was created. The highest priority is given to the oldest requests. A typical SQL statement that can be used is in the following table.

select * from mail_queue where being_processed_by is null and began_processing is null and
completed is null order by priority, created

In a step 304, a request object is created if one or more requests that need to be processed are detected in the queue. A “request object” is a C++ class object created for each and is placed in a “request pool”. Such object contains the topic and parameters, the sender's e-mail address, the system's e-mail address, etc. The composer process continuously threads to check the pool for pending request objects. Each object's member variables are populated with data from a corresponding row from a “mail_queue” table with columns for ID, priority, sender_e-mail, format, our_e-mail, addl_recipients, shortcut_ID, genre_ID (if defined), and parameters (if genre_ID is defined).

A step 306 marks the request as “being processed” to distinguish requests that are being processed from those that are either completed or new and unprocessed. For example, attributes in the “mail_queue” database table, are used as flags. A “being_processedby_column” e.g., is used to log the process that took on the respective request. Such process is preferably identified by its process_ID and machine on which it's running. The “began_processing” column is set to the date/time when the request was first acknowledged by the composer. Another SQL statement can be used to mark a request as being processed. For example in the next table, the process_ID is 40857, the hostname of the machine on which the composer is running is “chonburi”, and the request ID is 291,

update mail_queue set being_processed_by=‘composer.chonburi.40857’,
began_processing=now() where ID=291

A step 308 puts each such request object in a global “request pool” that is shared by the main the composer thread and all processing threads. The request pool is preferably protected and synchronized by mutex locking, and is used by the main thread when it puts new requests into the pool. Processor threads remove the requests from the pool as they appear instead of doing a database select from the “mail_queue” table. They simply fetch pending requests, already created and prioritized, from the request pool. So, as the main the composer thread finds new requests, creates request objects, and marks them being processed, it adds these request objects to the pool and continues iterating.

FIGS. 3B and 3C represent a composer processor thread loop. A step 310 looks to see if there is a request in the pool. Each composer processor thread constantly monitors the request pool for new, pending request objects. Lock contention and synchronization areas are handled by mutex locking to avoid two threads getting access to the same request object at the same time. If the processor thread finds a request object in the pool, it removes it from the pool and processes it. If there are no pending requests, the processor thread sleeps, e.g., for one hundred milliseconds, and checks again in a step 312. A step 314 selects the relevant account data from the database. The request may have come from a registered user or a non-registered user. If the user is registered, step 316 looks to make sure the account is still active, in case the user is trying to invoke a shortcut. Such method can be restricted in a business model embodiment to active, paying users. An SQL statement like that in the following table can be used to fetch any related account information and preferences.

select account.ID, if(now() < service_end, ‘Y’, ‘N’) as is_active, e-mail.is_primary,
preferences.want_ads from e-mail, account, preferences where upper(e-mail.e-
mail)=upper(‘dan@checkoway.com’) and account.ID=e-mail. account_ID and
preferences.account_ID=e-mail.account_ID

If a row is returned from the database query, and if the “is_active” column returned is ‘Y’, then the user is verified as an active subscriber or registered user. A step 318 determines the “wantAds” to be inserted in the answer. By default, an advertisement is served with the response message. If the database query returns a “want_ads” column with ‘N’, then no advertisement is included if the users account has not expired. A step 320 puts an account_ID in an “additional Data” hash. If the query returned a row, the registered user's “account_ID” is stored in the “additional Data” hash. Such hash generally contains any extraneous data that would otherwise be unrelated to the request being made. Providing the account_ID, however, enables the topic processor to be able to associate user-specific information with the request by identifying which user is making the request. A step 322 checks to see if the request a shortcut? If the request object's “shortcut_ID” is set, the genre_ID and parameters in the request object can be ignored, since the shortcut's queries are loaded in a later step. If not, a step 324 sets the outgoing message headers. A step 326 sets the shortcut name and description from the database. A “shortcut_ID” is found in the request object. In the case of a “normal” query, when the response message is constructed the parameters are entered and used to construct the subject of the outgoing message. For example, if the parameters are “Newport Beach, Calif.”, the subject would be “Re: Newport Beach, Calif.”. When a shortcut is invoked, the subject should be the shortcut's description, as specified by the user when the shortcut is first created. If a description has not been defined, the name of the shortcut is used. An example SQL statement to load the shortcut's name and description could be constructed like, “select name, description from shortcut where ID=857”. A step 328 checks to see if the account is active. A step 330 gets all shortcut entries from the database which can have one or more “entries” for a topic/qualifier pair. A shortcut with more than one entry is a “composite” shortcut. All the entries in a shortcut can be fetched with an SQL statement, e.g., “select genre_ID, parameters from shortcut_entry where shortcut_ID=857 order by ID”. The “is_active” value can be used to examine the active status of the account. If the account is inactive and a shortcut is being invoked, the request is rejected. In a business model embodiment of the present invention, the shortcut queries are only available to active users who are paid subscribers. A step 332 sends back a failure message instead of running the query. The resulting rows are alternatively read and each topic/qualifier pair is stored in a list. A basic error check is made to verify the list of pairs is not empty. Step 324 sets the outgoing message headers, based on the response format requested by the user. The outgoing message headers indicate the type of content being delivered. If the requested format is HTML, the headers are “Mime-Version: 1.0” and “Content-Type: text/html”. Otherwise, plain text results are indicated by “content-Type: text/plain”. To simplify tracking, embodiments preferably add a header to indicate the output format that the user originally requested, e.g., “X-Halibot-Format: html”.

Referring now to FIG. 3C, the process continues with a step 334 that builds the subject for an outgoing message. If a shortcut is being invoked, its description is used. If such description is unavailable, the shortcut name is used. Otherwise, the parameters are appended with “Re:”, as in “Re: Newport Beach, Calif.”. A step 336 connects to the SMTP server. A stream socket is opened on the client machine, and a connection is made to the mail server machine, e.g., on port 25. If the connection is made successfully, the client checks for a server response code, e.g., “220”. A step 338 initializes an SMTP request. Subsequent client/server transactions typically expect a response code from the server after each command of “250”.

A client uses a “HELO” command to identify itself to a server and sends a “RSET” command to ensure that a “session state” is clear. The client then sends a “MAIL FROM:” command to initiate a new message and declare a sender's return path. The “RCPT TO:” command is used to designate the recipients of the message. The “DATA” command is used to initiate the message content (a response code of “354” is expected). The client then sends the outgoing message headers, followed by one blank line (CR-NL) to signal the start of the message body. Here is an example of this transaction. Client commands are preceded with to differentiate. An example follows in the table.

220 localhost.localdomain ESMTP Sendmail 8.9.3/8.9.3; Mon, 8 May 2000 11:45:35 -0700
HELO server.halibot.com
250 localhost.localdomain Hello localhost.localdomain [127.0.0.1], pleased to meet you
RSET
250 Reset state
MAIL FROM: weather@halibot.com
250 weather@halibot.com... Sender ok
RCPT TO: dan@checkoway.com
250 dan@checkoway.com... Recipient ok
RCPT TO: neal@ivolio.com
250 neal@ivolio.com... Recipient ok
RCPT TO: jon@thispc.com
250 jon@thispc.com... Recipient ok
DATA
354 Enter mail, end with “.” on a line by itself
To: dan@checkoway.com
Cc: neal@ivolio.com, jon@thispc.com
From: weather@halibot.com
Reply-To: weather@halibot.com
Subject: Re: Newport Beach, CA
Date: Mon, 8 May 2000 14:37:29 -0700
Mime-Version: 1.0
Content-Type: text/plain
X-Halibot-Format: text
*

A step 340 looks to see if a header wrapper was defined for this format. The composer can automatically embed a standard header and/or footer in every response message, and the user can specify both text and HTML headers and footers. These are called “wrappers”, since the header and footer collectively “wrap” the content of the response. If a header wrapper was specified in the configuration file for the particular format being requested, this is appended to the response message before any other content is appended. A step 342 includes any expired account message. If the user account has expired, a message is inserted into the response about the expiration. Such message is customized and specified in the composer configuration file. A step 344 outputs a spacer. A spacer is inserted between each section of topic output in the response message for a composite shortcut. In the case of a plain text response, a series of hyphens are used, and in the case of HTML, a horizontal rule is used (e.g., <HR SIZE=6 COLOR=“#000000”>). A step 346 sends a request to an analyzer, or centralized topic server “call router”. The composer can simply post its request to this service, and the analyzer handles the rest, simply acting as a black box to produce the response. The communication between the composer and analyzer is HTTP. The composer posts to analyzer, typically a Java servlet, including the following parameters as form variables,

Account_ID: the ID of the user, if one has been identified
topic_name: the name of the topic to query
shortcut_ID: if the request is a shortcut, its ID
e-mail: the e-mail address of the user
subject: the query itself
body: the content of the message used to invoke this query
format: the response format desired, e.g., “raw”, “text”, “html”, or “wml”.

A step 348 receives a response. The analyzer routes the query and returns a response in the form of URL-encoded data. The composer receives the response via the HTTP connection and decodes the data into key/value pairs. The following keys may be provided in the response results:

the formatted response to the query
error_msg: if an error occurred, this contains a descriptive message about the problem
modified_subject: a potentially new, modified outgoing subject for the e-mail response
was_action: specified and set to ‘Y’ if the query performed an action/transaction, e.g.,
the body of the incoming message contained an action, such as a checked off item, or a quantity
entered next to an item to be purchased
Signature: a string identifying the topic server that provided the underlying response

A step 350 checks to see if there was an exception or output null. If either the “error msg” is non-null, or the output is null, the “handleNullOrErrorResponse” procedure is called to inform the user of this condition. It may be due to an improper invocation by the user. A step 352 converts the copyright to robust HTML. If the requested output format is HTML, the copyright is also converted to “robust” HTML by turning any links in the copyright to “clickable” links. For example, if the copyright is,

Information provided by Yahoo! Inc. http://www.yahoo.com
Copyright © 2000 Yahoo! Inc.

The converted copyright would be,

Information provided by Yahoo! Inc. <A
HREF=“http://www.yahoo.com”>http://www.yahoo.com</A>
Copyright © 2000 Yahoo! Inc.

A step 354 inserts an advertisement. If a “wantAds” variable is true, an advertisement is appended to the message. If the requested output format is HTML, a fully clickable banner ad image is inserted. Otherwise, a text-based advertisement is used. A step 356 checks to see if a footer wrapper is defined for the format. If there is a footer wrapper specified for the requested output format, it is appended to the outgoing message. A step 358 closes the SMTP connection and delivers the message. The client sends a single line containing only “.”, signifying the end of the message data. A “QUIT” command is then issued to close the SMTP connection. The sendmail server is responsible for delivering the fully constructed response message to the user. A step 360 marks the request object as “completed”, e.g., “update mail_queue set completed=now(where ID=291.” Program control returns to step 310.

A handleNullOrErrorResponse procedure is typically called whenever a topic query returns either an error or null output results. It is used to notify the user of potential causes for the problem, e.g., misusing the topic, as well as providing an automated help response. If there was an exception, and it has a non-zero error code, an error message will be appended to the response message, e.g., “specified an invalid qualifier”. If the output from the topic server was null, and the exception error code is zero, a message is added saying that no data was available for the user's request. When the user either encounters an error or gets no response for a particular query, the user is preferably provided with as much help as possible to prevent repeated problems in future queries. The system keeps track of how many times each user has encountered an error when using a particular topic. The first time an error occurs for a given user, they are provided with a topic description, a qualifier format, and an example qualifier. These get loaded from the database using an SQL statement, e.g., “select * from genre where lower(name=lower(‘directions’ and is_active=‘Y”’.

If such query doesn't return a row, the topic is most likely being invoked by an alias. Another SQL statement is to resolve it and fetch the parameters mentioned, e.g., “select genre.* from genre, genre_alias where lower(genre_alias.alias=lower(‘driving’ and genre. ID=genre_alias.genre_ID and genre.is_active=‘Y”’.

Each time a user misuses the system 100 and 200 or encounters problems while using a topic, a series of available “automated help messages” is rotated through that provides context-sensitive help. The general help is appended to the response message. The following table includes an, example of what is displayed the first time a user encounters an error. Thereafter the message changes as the rotation through the automated help database progresses.

Sorry, no data is available for that request, directions, “blah”.
Here's some general help on this topic in case you
may have forgotten how to use it properly.
Topic:
Directions@halibot.com
Description:
Point-to-point driving directions
Subject Format:
Origin-Destination
Example:
Napa, CA-100 Jackson St, San Francisco

When the user requests HTML responses, more robust help can be provided, e.g., by appending an “extended description” from the genre database table to the response message.

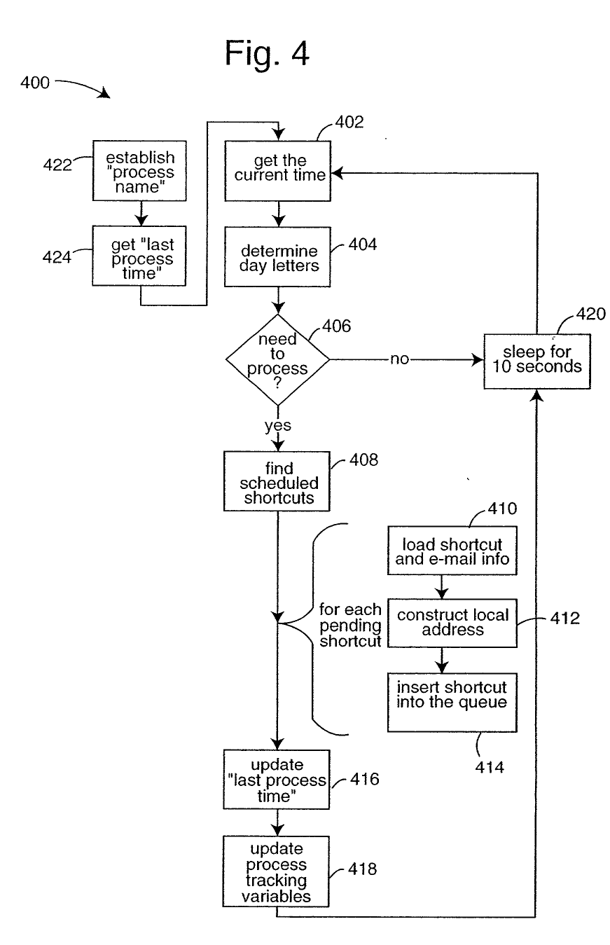

FIG. 4 represents a scheduler process 400. A step 402 gets the current time to establish a current system time. A step 404 determines any character day letters for today, yesterday, tomorrow. For example, if the current day of the week is Wednesday, today would be ‘W’, yesterday is ‘T’ (Tuesday), and tomorrow is ‘H’ (Thursday). A step 406 checks to see if processing is necessary. If the last day of the week the scheduler 114 and 216 ran was yesterday, any remaining events that were scheduled to go out yesterday are processed after the last time processing occurred. If this is the case, a “last time” variable is reset to zero to indicate that no processing was done “today”. A current time integer is built by multiplying the current hour by one hundred and adding the current minute, e.g., “1:05 pm” becomes “1305”. If today was the last weekday processing was done, and the last time when processing was done is equal to or after the current time, processing can be skipped. A step 408 finds any scheduled shortcuts that need handling. Three criteria determine whether a shortcut should be processed and delivered immediately. But something scheduled for “tomorrow” in another time zone might need to be delivered now, today in this time zone. If any one of the three criteria is true, a shortcut should be processed. The following SOL statement is an example,

select * from delivery_schedule where
(weekday=TODAY and
(time + zone-diff>lastTime and
(time + zone_diff <=currentTime
or
(weekday=TOMORROW and
(2400 + time + zone_diff>lastTime and
(2400 + time +zone_diff <=currentTime
or
(weekday=YESTERDAY and
(time + zone_{—diff - 2400>lastTime and}
(time + zone_diff - 2400 <=currentTime

A step 410 loads the shortcut information, e-mail address, and format. For each of the shortcuts that need processing, information about the shortcut is loaded. The e-mail address to which the shortcut should be delivered and the preferred output format for that e-mail address are also loaded. A step 412 constructs a local e-mail address. The shortcut name is used to construct the address from which the shortcut should be delivered. For example, if the shortcut name is “mystocks”, the local e-mail address will be “mystocks@halibot.com”. A step 414 inserts the shortcut into the queue. In order for the composer to pick up the shortcut and immediately process and deliver it, it is inserted it into the “mail_queue” database table.

insert into mail_queue(ID, created, priority, sender_e-mail,
format our_e-mail,
shortcut_ID values(null,
now(, 1, ‘dan@checkoway.com’, ‘A’,
‘mystocks@halibot.com’, 2994

A step 416 updates a “last process time”. Once all shortcuts that need to be processed have been scheduled, the “process_time” table is updated to indicate the last time processed. Such is done with a simple SQL statement, for example, assuming processing began at 2:01 am on Monday.

update process_time set last_weekday=‘M’, last_time=201
where name=‘production1’

A step 418 updates any process tracking variables to provide process tracking during the next iteration of the loop, e.g., the “last_weekday” and “last_time” variables are updated to indicate the latest round of processing. A step 420 puts the process to sleep for ten seconds. A step 422 establishes a process name, and a step 424 gets the last process time.

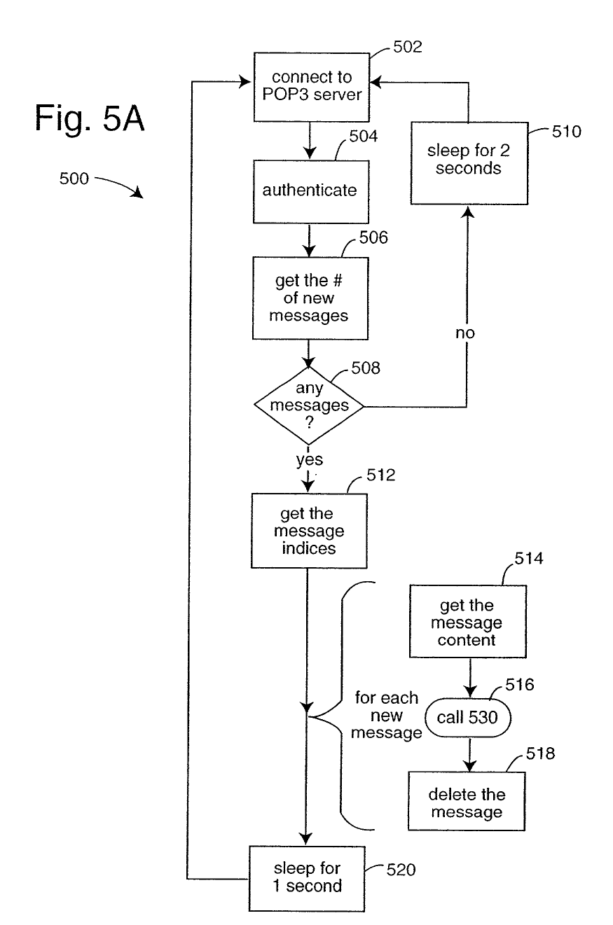

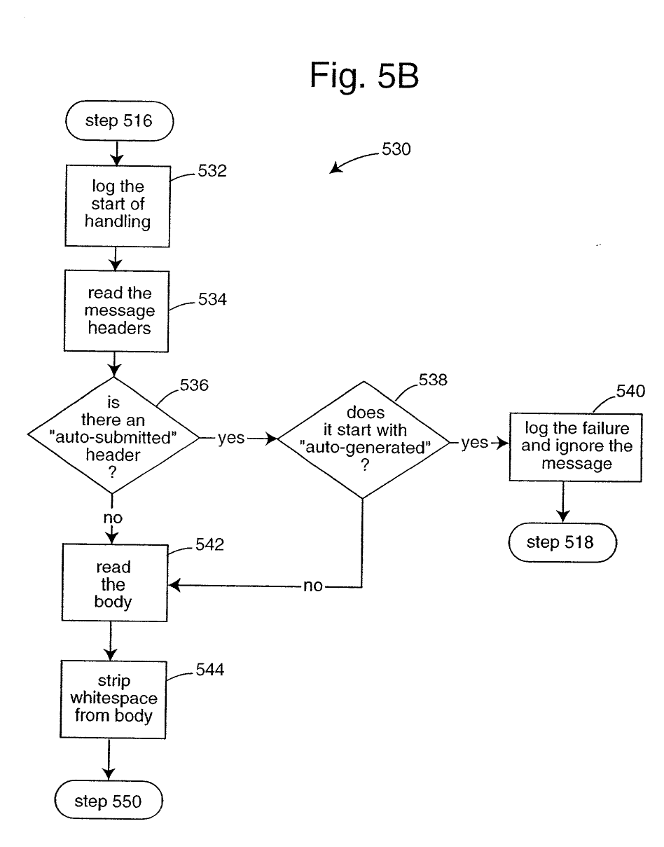

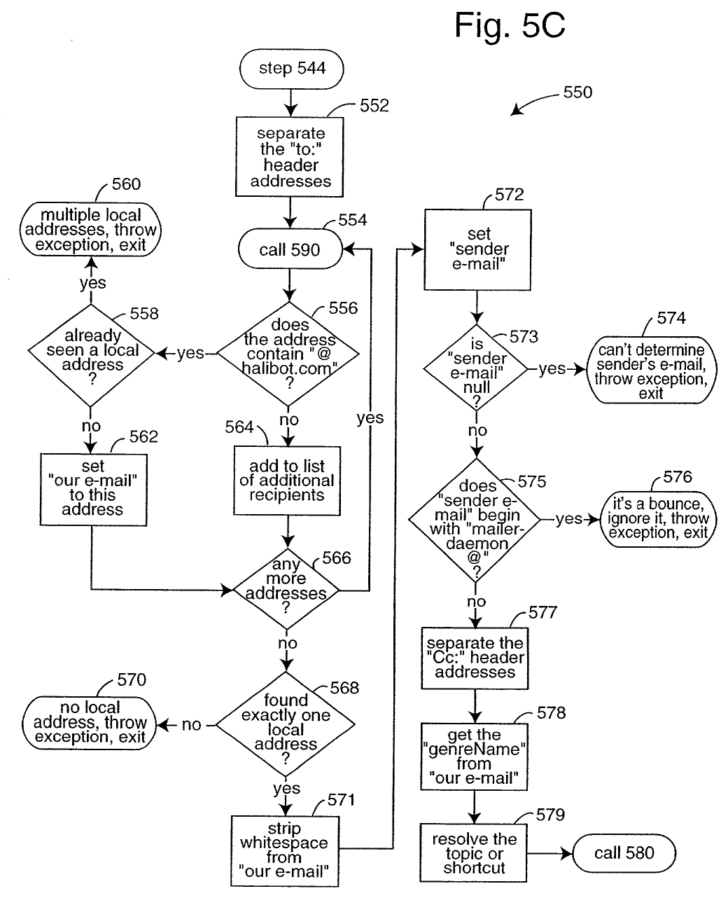

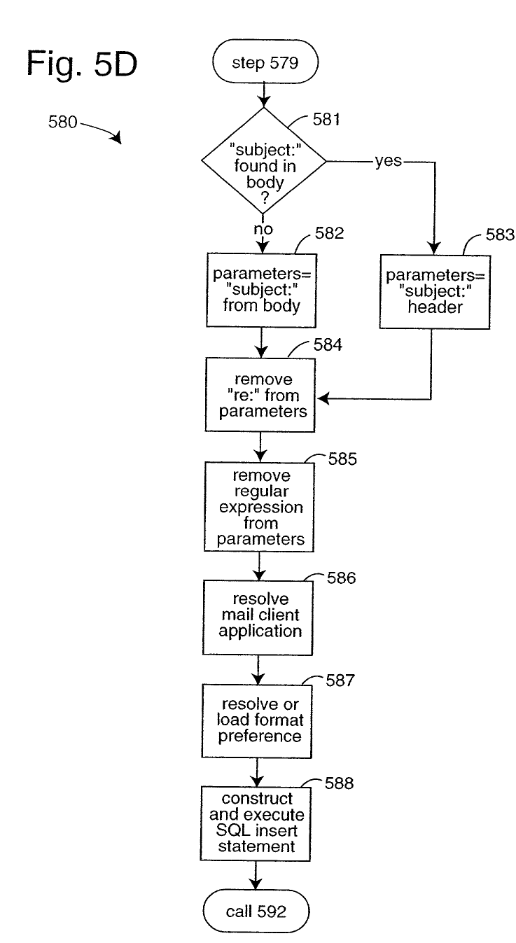

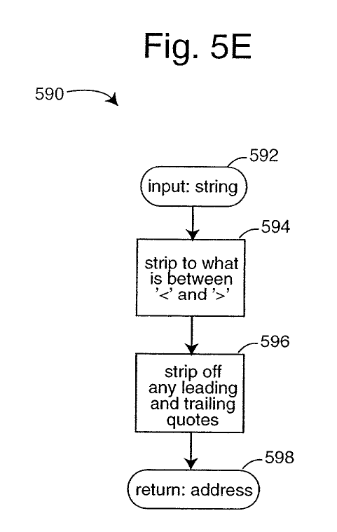

FIG. 5A represents a receiver process 500. A step 502 makes a connection to a POP3 server 108 and 208. A stream socket is opened on a client machine, and a connection is made to a server machine on port 110. If the connection is made successfully, the client makes sure a server's initial response line begins with “+OK” (as opposed to “-ERR”). A step 504 authenticates the connection. Assuming the POP mailbox in question is “halibot@halibot.com”, the client sends the command “USER halibot” followed by a CR (carriage return: MID) and NL (newline: 0x0A) to the server. The server response is checked for “+OK” or “-ERR”. Then, assuming the mail account password is “mypassword”, the client sends the command “PASS mypassword” (followed by CR-NL) to the server, and again the response is checked for “+OK” or “-ERR”. A step 506 gets the number of new messages. The client sends a command “STAT” (followed by CR-NL) to the server, which responds with a status line (“+OK” or “-ERR”). If the status is “+OK”, a single line follows that contains two numerical values, the number of messages and the number of octets (total size, in number of bytes, of all messages in the mailbox). The response line is parsed for these two tokens, and the number of messages is established. A step 508 checks to see if there are any messages, if not a branch back through a step 510 injects a two second sleep period. A step 512 gets any message indices. Each message in a POP mailbox has a numerical index associated with it that reflects the message's relative position in the mailbox. An index of one means the first message. An index of “21” means the twenty-first message, and so on. This index is used to retrieve and/or delete the respective message from the server. To get the list of message indices, the client sends the command “LIST” (followed by CR-NL) to the server, which responds with a status line (“+OK” or “-ERR”). If the status is “+OK”, the client reads all message indices from the server, one line at a time. Each line from the server contains two numerical values, the message index and the number of bytes representing the size of that message. The client stores all message indices in a list.

For each new message, a step 514 gets the message content. For the given message index, e.g., “7”, the client sends the command “RETR 7” to the server, which responds with a status line (“+OK” or “-ERR”). If the status is “+OK”, the client then reads the message content from the server, one line at a time. As soon as a line containing only “.” is encountered, this signals the end of the message and the client stops reading. A step 516 calls program 530 illustrated in FIG. 5B. On return from program 530, a step 518 deletes the message. For the given message index, e.g., “7”, the client sends the command “DELE 7” to the server, which responds with a status line (“+OK” or “-ERR”). A step 520 injects a one second sleep so the loop does not iterate too quickly.

What follows is an example of a standard client/server POP3 transaction that proceeds after a connection has been established. Server responses are shown beginning with a “+”, and client commands are shown in lines beginning with a “*”.

+OK POP3 localhost.localdomain v7.64 server ready
USER halibot
+OK User name accepted, password please
PASS myPassword
+OK Mailbox open, 2 messages
STAT
+OK2 1609
LIST
+OK Mailbox scan listing follows
1 890
2 719
.
RETR 1
+OK 890 octets
Return-Path: <dan@checkoway.com>
Received: from bung. checkoway.com (bung.checkoway.com [10.0.0.2])
by www.checkoway.com (8.8.7/8.8.7) with SMTP ID QAA13186
for <directions@halibot.com>; Fri, 5 May 2000 16:21:26 -0700
Message-ID: <003901bfb6e8$blc663a0$0200000a@checkoway.com>
From: “Dan Checkoway” <dan@checkoway.com>
To: <directions@halibot.com>
Subject: Newport Beach, CA - Venice, CA
Date: Fri, 5 May 2000 16:21:51 -0700
MIME-Version: 1.0
Content-Type: text/plain;
charset=“iso-8859- 1”
Content-Transfer-Encoding: 7bit
X-Priority: 3.
X-MSMail-Priority: Normal
X-Mailer: Microsoft Outlook Express 5.00.2919.6600
X-MimeOLE: Produced By Microsoft MimeOLE V5.00.2919.6600
Status: O
DELE 1
+OK Message deleted
RETR 2
+OK 719 octets
Return-Path: <dcheckoway@wyndtell.com>
Received: from nova. wyndtell.com
(nova.wyndtell.com [63.81.201.78])
by nsl.wyndtell.com (8.9.3/8.9.3) with ESMTP ID QAA24941
for <weather@halibot.com>; Fri, 5 May 2000 16:22:41 -0700.
From: dcheckoway@wyndtell.com (Dan Checkoway)
To: weather@halibot.com
Subject: Newport Beach, CA
Message-Id: <15360888.1 553@wyndtell.com>
Date: Fri, 05 May 2000 16:22:41 -0700
Status:
DELE 2
+OK Message deleted
QUIT
+OK Sayonara

FIG. 5B illustrates a handleNewMessage procedure 530. A step 532 logs the start of handling a new message. When this procedure is first called, information is inserted into a receiver log file that indicates that a new message is being processed. Information includes the current date/time, the message index and the content length of the message. A step 534 reads message headers from the message content. Typical e-mail messages have two structural components, message headers and message bodies. The message headers are parameter/value pairs that provide information such as who sent the message, to whom the message was sent, what application was used to generate the mail, and the subject of the message. The format of a single parameter/value pair is “Parameter: Value”, e.g., “To: weather@halibot.com”. Such usually takes a single line of text. If the value is long, the header can span multiple lines, e.g., “Received: from nova.wyndtell.com (nova.wyndtell.com [63.81.201.78]), by nsl.wyndtell.com (8.9.3/8.9.3) with ESMTP ID QAA24941, for <weather@halibot.com>; Fri, May 5, 2000 16:22:41-0700”. The process of reading headers involves parsing the message content, one line at a time, building a dictionary of the parameters and their values. A blank line signifies the end of the headers and the beginning of the message body. A step 536 checks if it is an “auto-submitted” header. If yes, a step 538 checks to see if it starts with “auto-generated”. Whenever an attempt is made to send e-mail to a non-existing account, “sendmail” will preferably reply to the sender with a “bounce” message with the following header, “auto-submitted: auto-generated (failure)”. If an “auto-submitted:” header is encountered, and if the value of that header begins with “auto-generated”, the message received is a “bounce” message and not a legitimate, normal message. If this is the case the incoming message is ignored in a step 540. Control returns to step 518. A step 542 reads the body from the message content. The headers are separated from the message body by a blank line. A step 544 strips leading and trailing whitespace from the body. “Whitespace” is a common term that refers to any characters used for spacing, such as a space (0x20), tab (0x09), carriage return (0x0D), or newline (0x0A). Any of these characters that lie at the very beginning and end of the message body are removed to strip the body down to bare text.

FIG. 5C illustrates an insertintoQueue procedure 550. A step 552 separates the “To:” header into a list of addresses. It is possible that multiple recipients may be specified in the “To:” header, as opposed to just one address. If multiple addresses are specified, they need to be parsed into a list of addresses. The delimiter used in the “To:” header is the comma character. A step 554 is a call procedure 590 (FIG. 5E). A step 556 looks to see if the message contains “@halibot.com”, for example. Iterations are made through each address in the “To:” header while searching for a single address ending with “@halibot.com”. Such designates a topic a user is querying, e.g., “weather@halibot.com”. If the address currently being examined ends with “@halibot.com” in case-insensitive comparison, it is considered a “local” address. A step 558 sees if a local address has already been seen. At this point, an address has been found in the list of “To:” addresses that ends in “@halibot.com”. Only one topic is allowed. A variable “ourE-mail” is stored to designate the local topic e-mail address that is being invoked. If this variable has already been set and it's non-null, there are more than one local addresses in the “To:” header. Such triggers an error condition in a step 560. If the “ourE-mail” variable has not yet been set (it's null), this local address is the first one seen, and a step 562 sets “ourE-mail” to this address, and iterating continues. A step 564 adds this e-mail address to the list of additional recipients, the address in question doesn't contain “@halibot.com” so it is not considered a local address. It is simply added to a list of additional recipients who will ultimately be copied on the response. A step 566 looks for more addresses. Once iterating through the “To:” header's e-mail addresses is complete, a step 568 looks to see that there is one and only one local address, e.g., ending in “@halibot.com”, to signify the topic being queried. If the “ourE-mail” variable has not been set (it's null), there is no way of determining which topic is being queried, and so a step 570 is an exit for the error condition. A step 571 strips any leading and trailing whitespace from “ourE-mail” and checks for a “Reply-To:” header, in order to keep track of who sent this e-mail message. The sender's e-mail address is stored in the “senderE-mail” variable in a step 572. If there exists a “Reply-To:” header, “senderE-mail” is set to the value of that header. If not, “senderE-mail” is set to the value of the “From:” header which may not be defined. If “senderE-mail” is null in a step 573, there no way of determining the sender's e-mail address. This is an error condition, and exits at a step 574. A step 575 sees if the senderE-mail begins with “mailer-daemon@”. If the “senderE-mail” variable starts with “mailer-daemon@”, consider the message to be a “bounce” message, not a legitimate, normal message. If this is the case, the message is ignored in a step 576. A step 577 separates the “Cc:” header into a list of addresses. The same process is used to separate addresses that may be specified in the “Cc:” header. It is important to verify that each e-mail address is valid to avoid a bounce back. Valid e-mail addresses will pass the following tests.

It must contain an‘@’ character
The ‘@’ must not be the first or last character in the string
A ‘.’ character must not immediately precede or follow the ‘@’
The last ‘.’ Character must come after the ‘@’
The ‘.’ must not be the last character in the string
The string must not contain any spaces

In a step 578 the “genreName” is parsed. In order to determine the genre or “topic”, the “ourE-mail” variable is examined and truncated up to but not including the “@”' character. For example, in the case of “weather@halibot.com”, “genreName” is set to “weather”. Then a check is made to see if there is an entry in the “genre” database table, in order to validate the topic that the user is querying. An active entry in the “genre” database table with a name matching the “genreName” is parsed out of the e-mail address, e.g., using “weather”, “select ID from genre where upper(name)=upper(‘weather’) and is active=‘Y’”. If this query returns a valid genre, the ID is stored in the “genreld” variable. A step 579 looks to see if the sender has a shortcut with that name. It's possible that the user is invoking a “shortcut” if a matching active topic is not found in the database. This step can check to see if the sender has a shortcut with the same name (using “dan@checkoway.com” as an example for “senderE-mail” and “mywx@halibot.com” as an example for “ourE-mail”),

select shortcut.ID from e-mail,shortcut where upper(e-mail.e-
mail)=upper(‘dan@checkoway.com’) and
shortcut.account_ID=e-mail.account_ID and
upper(shortcut.name)=upper(‘mywx’)

If this query returns a valid shortcut, it is stored in the ID in the “shortcut” variable. If there are genre alias with that name, or a matching active topic or, shortcut was not found in the database, it's possible that the user is invoking a topic by using one of many aliases possible. For example, the “airfare” topic has fares, lowfare, lowfares. In the following SQL statement, “lowfare@halibot.com” is used to illustrate this point.

“select genre.ID from genre alias, genre where
upper(genre_alias.alias)=upper=(‘lowfare’)
and genre.ID=genre_alias.genre_ID and
genre.is_active=‘Y’.”-

If this query returns a valid genre, it is stored the ID in the “genreld” variable. The system now knows what topic the user is querying.

A step 581 sees if the first line of the message body begins with “Subject:”. Some devices do not support the ability for users to specify the subject of an outgoing e-mail address. For example, some cell phones will hard-code the subject of all outgoing messages to something like “MESSAGE FROM MOBILE”. This would ordinarily preclude users of these devices from being able to use our system. To compensate, users are allowed to “override” the subject in the body of the message by making sure the first line in the body starts with “Subject:”. For example, if this were the first line in the message body, “Subject: Newport Beach, Calif.”, everything following “Subject:” is taken and overrides the “Subject:” header with this value. A step 582 gets the needed parameters from the message body. A step 583 gets them from the subject header. A step 584 removes any “Re:” from the parameters. Typically, when e-mail client applications compose replies to messages, “Re:” is prepended to the subject of the reply message. For example, if a user replied to a prior response, the subject of their new message sent to us might be, “Subject: Re: Newport Beach, Calif.”. In order to compensate for this, all instances of “Re:” are removed from the subject. A step 585 removes regular expression from parameters. Some e-mail client applications keep track of how many times a message has been replied to, and they include a numerical counter in the reply “prefix”. For example, on the second reply to a given message, the subject may be “Subject: re[2]: Newport Beach, Calif.”. The “2” doesn't appear every time, and on the third reply it would be “3”, etc. To compensate for this, a regular expression is used to detect and strip out all instances of these numerically counted reply prefixes. The regular expression is [Rr]e\[[0-9]*\].

A check is made to see if there is an “X-Mailer:” header. In order to best serve the user, the system provides as robust a response as possible. If the e-mail client application they are using supports HTML, the system will send an HTML response. If the client application they use doesn't support HTML, the system will send plain text. Most e-mail clients identify themselves within the headers of every e-mail message they compose. This is done by use of the “X-Mailer:” header. If this header is seen, the identified e-mail client is remembered.

A check is made to see if there is a “User-Agent:” header. Some e-mail client applications are non-standard and do not conform to the rules about the “X-Mailer:” header. Some of them make use of the “User-Agent:” header instead. If the “X-Mailer:” header is missing, the system looks for the “User-Agent:” header and interpret it in exactly the same manner.

A step 586 sees if the parameters contain format keywords. Typically, the most appropriate format of the response is automatically chosen based on the known capabilities of the identified e-mail client application. Sometimes, however, a user may want the ability to override this feature. For example, if the user wants text results where they would ordinarily be delivered in HTML, a mechanism for controlling that behavior must be provided. This is accomplished through use of “format keywords”. In the subject of the message, users can embed keywords to control format, e.g., [text], [html], [wml], [raw], etc. A step 587 loads format from the e-mail table in the database. If any explicit format keywords were not found, a check is made to see that the user prefers an “auto-detection” of the most appropriate format before that choice is made for them. The alternative would be for a user to have previously specified a fixed format that they always want to receive. This format is stored with each e-mail address in the database (the “format” column in the “e-mail” table). By default, the value is ‘A’ (auto-detect), but it can be ‘T’ (text); or ‘H’ (HTML). A step 588 constructs and executes an SQL insert string. In order to communicate to other back-end processes that there has been a request that needs to be processed, a row is inserted into the “mail_queue” database table. A typical insert SQL statement looks like this insert into mail_queue(ID, created, priority, being_processed_by, began_processing, completed, sender_e-mail, x_mailer, format, our_e-mail, addl_recipients, genre_ID, parameters, shortcut_ID) values(null, now( ), 0, null, null, null, ‘dan@checkoway.com’, ‘Microsoft Outlook Express 5.00.2919.6600’, ‘A’, ‘weather@halibot.com’, ‘copymy@friend.com’, 8, ‘Newport Beach, Calif.’, null.

FIG. 5E begins with a step 592 that gets an “embedded” e-mail address from a string. A step 594 strips it down to only what is contained between ‘<’ and ‘>.’

When e-mail messages get sent, sometimes e-mail addresses get “resolved” by the mail server into people's real names, which get displayed right alongside the e-mail addresses “From: “Dan Checkoway” <dan@checkoway.com>”. The parsing for e-mail addresses looks for the “embedded” e-mail address. The string is stripped down to only that which lies between the ‘<’ and ‘>’ characters. A step 596 strips off any leading and trailing quotes. Sometimes, the e-mail address is bracketed between ‘<’ and ‘>’, The e-mail client application places either single or double quotes around the embedded address. These quotes are stripped off the ends of the e-mail address in a step 596 to establish the bare address. A step 598 returns the address.

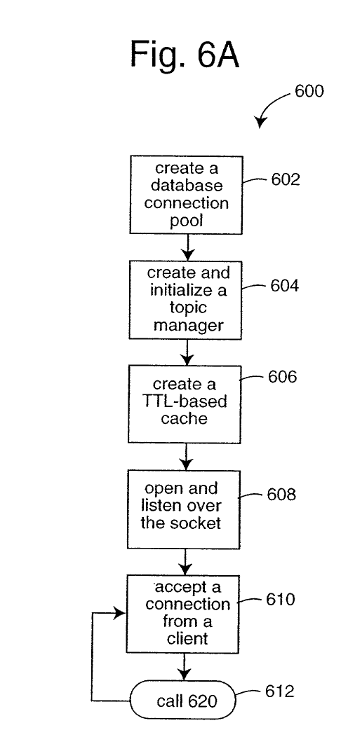

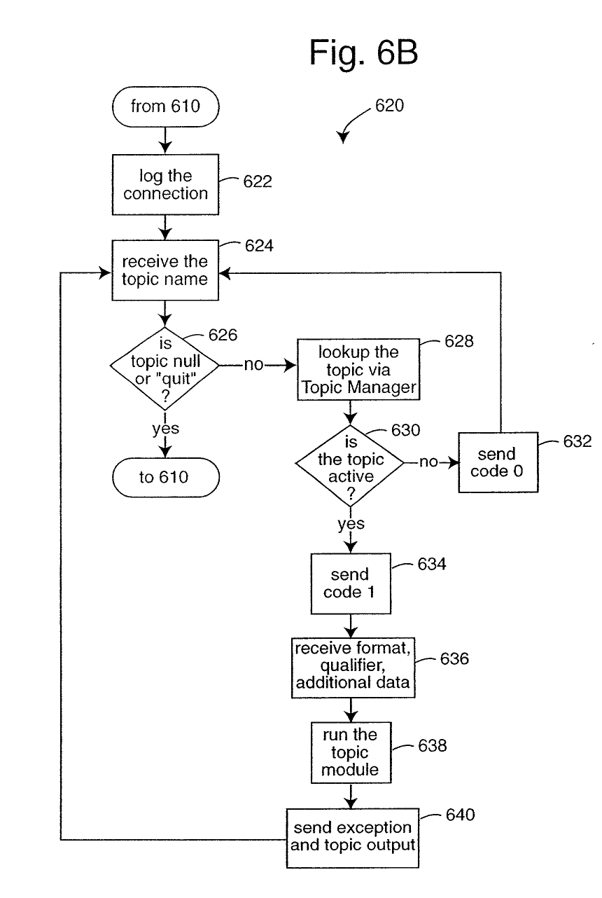

FIGS. 6A and 6B illustrate a topic server embodiment of the present invention. The topic server is a critical component of the system. Much of the code that actually implements the parsing of queries and the fetching, trimming, and formatting of data exists in a library of “topic modules”. Each topic module is created to serve one and only one topic. For example, separate topics are created to serve the weather and almanac topics. A topic is responsible for parsing input based on its particular qualifier syntax, producing or retrieving and filtering results based on the qualifier, and returning results in all supported output formats. Each topic module is typically implemented in C++ programming code. A core library of several topic modules is used. Each of these class objects are derived from a virtual base class wherein active topics are tied to their respective implementations by a “module_classname” column in the “genre” table. For example, a “thesaurus” topic has “dcThesaurus” as its module name. A “dcThesaurus” is a C++ class object that resides in the topic library.

To illustrate specifically the way a topic is implemented, dcThesaurus.cpp is included here for reference (stripped down to the bare essence-the run( ) and getRawResults( ) methods-and simplified slightly for clarity):

void dcThesaurus::run(const dcCString &input,
ostream &out,
outputFormat fmt,
ostream &log)
throw (const dcError &)
{
log <<“dcThesaurus module is running”<<end1;
dcCString response;
if (!getRawResults(input, response, fmt, pool,
additionalData, cache, out, log)∥
response.isNull( )){
return;
}
if (fmt= =raw){
out<<response;
return;
}
else if (frnt = =html) {
changeHTMLTargets(response);
out<<response;
return;
}
response. strip( );
response.foldSpaces( );
response.replaceAll(“\n.”, “\n”);
response.replaceAll(“:\t”, “:”);
response.removeAll(‘\n’);
response.replaceAll(“</tr>“, “\n”, dcCString::ignoreCase);
response.replaceAll(“<BR”, “\n<BR”, dcCString::ignoreCase);
response.replaceAll(“<sup>1</sup>”, ““, dcCString::ignoreCase);
dcCString body=stripHTMLTags(response);
body.strip( );
body.foldSpaces( );
body.replaceAll(“:”, “:”);
body.replaceAll(“\n”, “\n”);
out<<body;
}
dcBoolean dcThesaurus::getRawResults(const dcCString &input,
dcCString &response,
ostream &log)
throw (const deError &)
{
dcURL url(“http://www.m-w.com/cgi-bin/thesaurus?book=
Thesaurus&va=“+
encode(input));
url.fetch( );
url.getFullyQualifiedContent(response);
log<<“Translating response from server”<<end1;
if (?response.truncateLeftAt(“Entry Word”)) {
return FALSE;
}
response.truncateRightAt(“</form”, dcCString::ignoreCase);
return TRUE;
}

When a topic module is run, it first gets a “raw” result by fetching an HTML web page via HTTP from a known data source. The HTML is trimmed down to its bare essentials. Once these raw results are established, the topic module branches based on the requested output format, and either returns the raw results, HTML results (with minor modifications, such as fully qualifying all links), or text results. The latter case is the one that involves the most per-topic custom implementation. Each topic is responsible for stripping and/or parsing the raw HTML results and returning them in meaningful, well-laid-out text format. Each topic module is uniquely adapted to its data source's particular style of HTML.

The data sources for topic modules are not limited in any way to HTML web pages fetched or posted to via HTTP. In many cases, the data sources are in-house, living within the same main database as user account information. Examples of these kinds of topics would be “zip code” and “area code”. No matter how the information is retrieved, each topic module abstracks away the methodology and acts as a black box that the topic server can make use of at any time without having any knowledge of where the information is coming from or how it gets processed. This is the true essence of topic 5 server's design.

As the topic server handles requests, it needs to know how to properly dispatch a request for a particular topic. Correlation between a topic name and a topic module are made by a “topic manager” gateway between the topic server, the database, and each of the topic modules.

In FIG. 6A, a topic server 600 comprises a step 602 that creates a database connection pool to minimize the impact of needing to connect and disconnect from the database every time a query needs to be executed. So a pool of persistent database connections is preferably created. Such connection pool starts out with zero open connections to the database. As the database is needed by various threads running simultaneously, connections are opened and the pool grows in size. The maximum number of connections in the pool is fixed upon creation, based on a value specified in the configuration file. Typically the number of allowable database connections is half the number of threads the topic server uses to process requests. The connection pool is implemented in form of a C++ object that is passed to each topic module when it executes a query. Mutex locking prevents multiple threads from using the same database connection simultaneously. In fact, if the connection pool size was sixteen, and seventeen threads needed connections to the database, one thread would end up waiting until a connection was freed up.

When the topic server starts up, it creates a topic manager object. This loads all the relevant topic information from the database, and creates a topic module object for each active, implemented topic. Whenever the topic server needs to handle a request for a given topic (by name), it asks the topic manager for a handle to the respective topic module. The topic manager is initialized in a step 604 with an SQL statement, e.g., “select id, name, module_classname from genre where is_active=‘Y’ and module_classname is not null order by name”. For each row returned by this query, the topic manager creates a topic module object, with a name specified in a “module_classname” column. As topic manager creates these topic module objects, it simultaneously creates a “mapping” between them and topic names. This mapping can be used at any time to get a handle to the respective topic module object for a given topic name. While building the topic mapping, the topic manager also loads all “aliases” for each topic. An alias is another name that the topic can be called (for example, “driving” is an alias for “directions”). All aliases for a given topic are also mapped to the respective topic module objects.

A step 606 creates a time-to-live (TTL) based cache in order to boost performance. Topic modules can use it to temporarily store raw results and avoid re-issuing the information request. The time-to-live means that the entry lifetime is specified, and after being expired the data is flushed from the cache. Each topic module is responsible for making sure that time-sensitive data is cached for an appropriate amount of time. Data that is less sensitive can be cached for much longer periods. In general, an advantage of using such cache is the improved performance of repetitive or common queries. A repeated query can be processed nearly instantaneously by using cached data. A step 608 opens a socket and listens for client connections. There is a pool of server threads, each of which is constantly accepting a client connection over the socket. Whenever a connection is established in a step 610, the respective server thread processes the client's request(s) by a step 612 that calls a process 620 (FIG. 613).

In FIG. 613, a step 622 logs the connection by inserting an entry in a log file. This means that the client has connected and the session has begun. A step 624 receives the topic name. The client sends a string to indicate the name of the topic being queried. A step 626 checks to see if the topic is a null. If not, a step 628 looks up the topic via a topic manager. A handle is established to a topic module object associated with the given named topic. A step 630 checks to see if the topic is active. If not, a code-0 response is returned by a step 632. If active, a step 634 sends a code-1 response. A step 636 receives format, qualifier, and other data from the client. Two length-prefixed strings are sent over the socket, the requested output format and the topic qualifier. After that, an “additional Data” hash is sent, e.g., first the number of entries, then each length-prefixed key and value. A step 638 runs the topic module. All the information needed to run the query is on hand. The topic module object's run( ) method is called with all relevant parameters. A step 640 sends any exception and the topic output to the client.

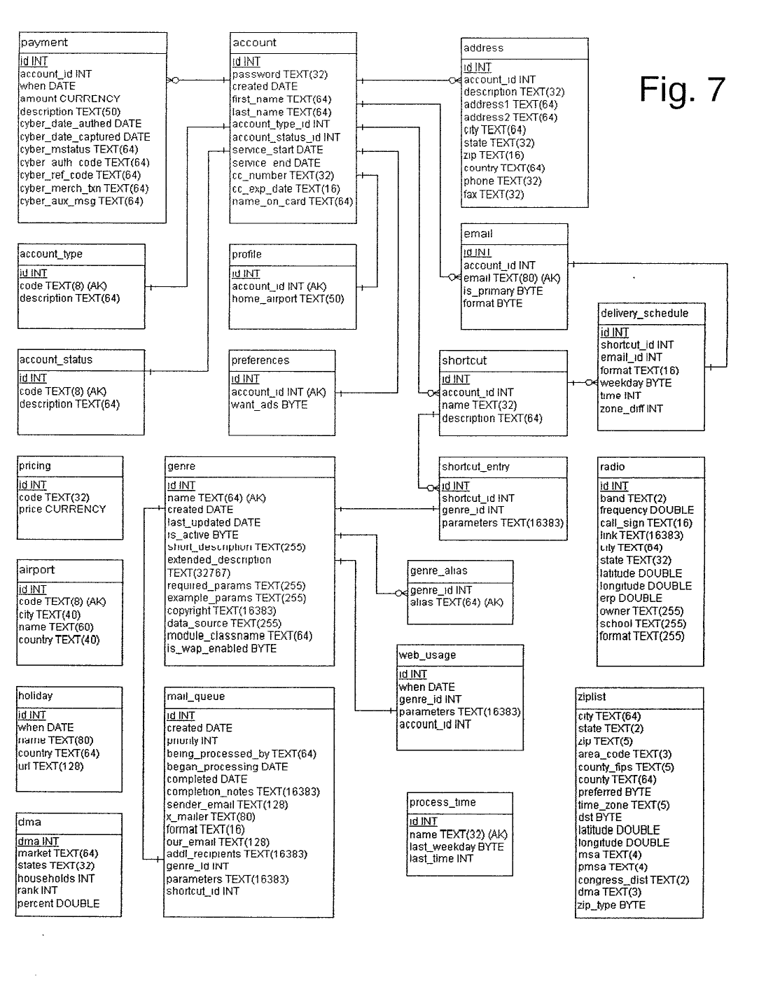

FIG. 7 represents one way to organize databases 112 and 212. Such databases typically include a “mail_queue” table. Whenever an e-mail query is received by receiver 110 and 210, an entry is stored in this table. The composers 116 and 218 pick up and handle requests that are pending. The following Table is typical of the mail-queue table's structure.

mail queue

| Column Name | Description |
|---|---|
| ID | Primary key, row identifier |
| Created | Date/time when the request was created |
| Priority | Numerical priority of the request, 0 is the highest priority |
| being_processed_by | Name of the process that is handling the request |
| began_processing | Date/time when the request was first picked a for handling |
| Completed | Date/time when the request was finished being handled |
| completion_notes | Notes about an error conditions that occurred while handling |
| sender_e-mail | E-mail address of the person making the request |
| x_mailer | E-mail client application identifier, e.g., “Microsoft Outlook Express... |
| Format | Requested output format, e.g., “html” or “text” |
| our_e-mail | E-mail address to which the request was sent, e.g., |
| | “weather@halibot.com” |
| addl_recipients | Additional e-mail addresses that get copied on the response |
| genre ID | Id of the topic being queried |
| Parameters | Query parameters |
| shortcut_ID | Optional ID of a shortcut being invoked, instead of genre ID/parameters |

Each request is queried against a given topic. Topics are defined in a “genre” table, e.g.,

genre

| Column Name | Description |
|---|---|
| ID | Primary key, row identifier |
| Name | Name of the topic, e. ., “weather”, “golf” |
| Created | Date/time when the topic was created |
| last_updated | Date/time when changes were last made to the |
| | topic |
| is_active | ‘Y’ or ‘N’ to indicate whether the topic is active |
| short_description | Brief one-line description |
| extended_description | Full description |
| required_params | Qualifier syntax, e.g., ”BusinessName, Location” |
| example_params | Example of the qualifier syntax, e.g., “Shoe |
| | Repair, Newport Beach, CA” |
| Copyright | Co right/attribution for the topic's data source |
| data_source | Internal tracking of the topic data source |
| module_classname | Implementation's C++ class object name, e.g., |
| | “dcWeather” |
| is_wap_enabled | ‘Y’ or ‘N’ to indicate whether the topic is |
| | supported under WAP |

These two tables are sufficient for a minimal system that can do “anonymous” request processing. An extended system adds user identifiers. Each user has an “account” table that includes basic information, e.g., first and last name, account status, credit card number, and credit card expiration date. Each row in the “account” table preferably has a corresponding row in both the “profile” and “preferences” tables. Such “profile” table stores information that defines the user, user lifestyle and location. The “preference” table stores information about how the user prefers to be treated, e.g., whether the user wants advertisements included in responses. Each user also has one or more row in the “address” table, one for home, one for work, plus additional custom user-defined addresses. Each user may have entries in a “payment” table which records all user payment events. Trial, non-paying users, do not have payment entries. Registered users have at least one payment, the cost of the initial subscription.

Each user has at least one row in an “e-mail” table, and each row corresponds to a unique e-mail address that belongs to a given user. Such provides the link between a request and the registered user, “sender_e-mail” in the “mail_queue” table will equal the user's e-mail address. With this link, the user's profile, preferences, and addresses are known so a personalized, meaningful response can be generated.

Users can also create shortcuts, which simplify the process of making common requests. Each shortcut stored in a “shortcut” table has one or more row in a “shortcut_entry” table. Each “shortcut_entry” represents a topic/qualifier pair. A “composite” shortcut has more than one “shortcut_entry”.

Users can preferably schedule automatic delivery of queries that are facilitated by a “delivery_schedule” table. Once a shortcut is created, it is tied to an e-mail address and a day/time to be delivered. The scheduler 114 and 216 uses the “delivery_schedule” table to determine requests that need to be delivered, and then insert the respective entries into the “mail_queue” table for processing.

Alternatively, more tables can be included that provide data for internally implemented topics, e.g., “radio” (a database of radio stations), “airport” (worldwide airport information); “ziplist” (zip codes), area codes, and associated latitude/longitude locations.

“Virtual GPS” and custom keyword addresses methods are preferably included that allow users to identify and change their geographic locations dynamically, e.g., so information about goods and services can be constrained to list only local providers. An exemplary custom keyword addresses method allows users to send an e-mail to address @ halibot.com with a subject line, “HQ=15 Sunset Ave, Miami, Fla., 33133”. Two keyword addresses are reserved for “Home” and “Work”. This allows the user to subsequently enter “HQ” or any other custom keyword address a current location for when a location is required to provide information with geographic proximity.

The virtual GPS method allows a user to notify the system 100 and 200 via e-mail or the web about a current location. For example, the user sends e-mail to “iamhere@halibot.com” with the subject line containing a current zip code, city, state, full address, custom keyword address, etc. For example, “Subject: HQ” or “Subject: 94133” or “Subject: 723 Vallejo St, San Francisco, Calif. 94133”. Such user can then omit the location in later queries. In which case the system 100 and 200 preferably assumes that the user's location is the one last entered using the virtual GPS method. The user can use this method at any time to dynamically change the location treated by the system 100 and 200 as the “default location”. Functionality is provided to enable the user to retrieve or display the current “default location” via e-mail or the web.

An action/transaction method is preferably included that enables e-mail users to get additional information about a particular answer element provided by the system 100 and 200 in response to a query, to select an answer element and to “forward” it to a different “topic” for the purpose of conducting a new query, to initiate, invoke or conduct a transaction or other process. The system 100 and 200 typically appends a textual trigger entry mechanism to actionable answer elements. For example, a business name and address that has been delivered as a result of a previous query. Specific trigger entry mechanisms can be variable, and can include sequence numbers or sets of brackets associated with each answer element, e.g.,

| [] | Galletti Brothers Shoe Repair |
|---|---|
| 427 Columbus Ave | |
| San Francisco, CA | |
| ,415 982-2897 | |
| 0.0 miles | |
| [] | USA Shoe Repair |

586 Washington St
San Francisco, CA
,415 781-7715
0.3 miles

A user “forwards” e-mail containing the answer element to a new address that can provide additional information or other action/transaction. For example, if the user wishes to get driving directions from a current default address to one of the answer elements, the user can “Forward” the e-mail to directions@halibot.com, for example. Each user “selects” a desired answer element that is to be “acted upon” by activating a specific trigger entry mechanism. For example, the user can enter an “x” in the brackets of the answer element selected, as in the following,

| [] | Galletti Brothers Shoe Repair |
|---|---|
| 427 Columbus Ave | |
| San Francisco, CA | |
| ,415 982-2897 | |
| 0.0 miles | |
| [] | USA Shoe Repair |

586 Washington St
San Francisco, CA
,415 781-7715
0.3 miles

The system 100 and 200 receives “forwarded” e-mail and appropriately identifies answer element selected. Based on forwarded address and various other factors, the system processes requests as required. The system 100 and 200 sends an appropriate response back to user, if required, which may include delivery of a new answer set, an additional request form requiring entry, or some other information.

The scheduler 114 and 216 is responsible for making sure all scheduled events get delivered on time, so there needs to be a backup in case of a failure. Such backup can be a simple storage mechanism in the database where a record of the last time the process was run is stored. In order to make this mechanism generic, there is a universal “process_time” database table that serves as the storage point for all time-sensitive applications. Thus, each application must uniquely identify itself when storing data in this table. The scheduler 114 and 216, when launched, is passed a “process name” in the command line parameters. Such value is stored and used for identification.

The scheduler 114 and 216 stores the “last process time” in the “process_time” database table. Included in this data are the weekday, a character representing a day of the week: “SMTWHFA” and the time of day, an integer whose hundreds are the hour and tens are the minute; e.g., 2205 means 10:05 pm. When the scheduler 114 and 216 first starts up, a look is made to see when processing was last done. This data is loaded from the table using an SQL statement, e.g., “select * from process_time where name=‘production1’”. The “last_weekday” and “last_time” attributes are loaded for keeping track of processing time.

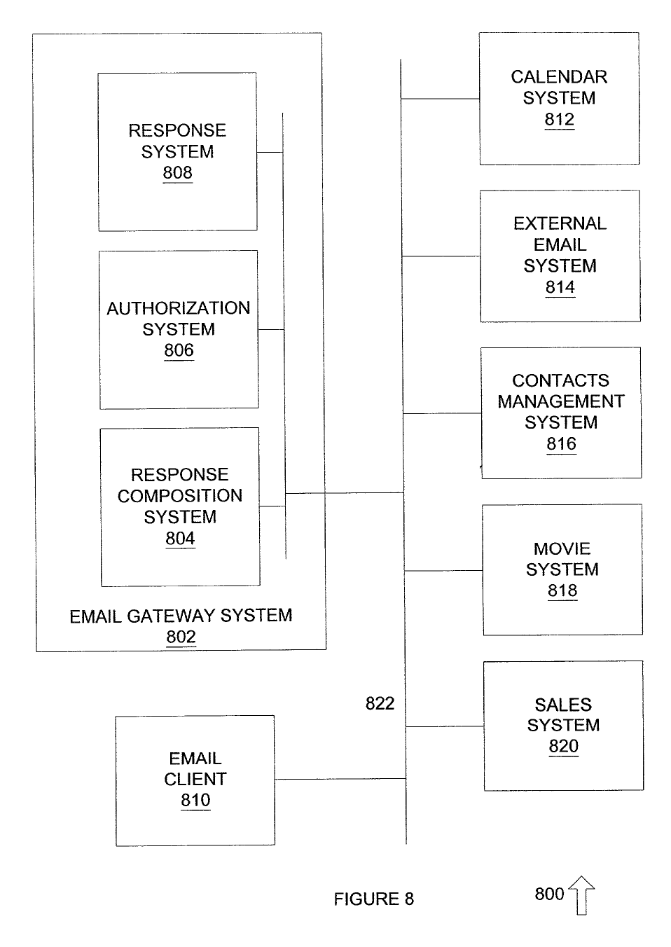

FIG. 8 is a diagram of a system 800 for providing an e-mail access gateway in accordance with an exemplary embodiment of the present invention. System 800 allows the user to access data or system functions using standard e-mail, such that any e-mail enabled device can be used to access data and system functions. System 800 can be implemented in conjunction with an e-mail answering agent, such as e-mail answering agent 100 or 200, or other suitable systems and processes.

System 800 includes e-mail gateway system 802, which can be implemented in hardware, software, or a suitable combination of hardware and software, in which can be one or more software systems operating on a general purpose server platform. As used herein, a software system can include one or more objects, agents, threads, line of code, subroutines, separate software applications, two or more lines of code or other suitable software structures operating in two or more separate software applications, on two or more different processors, or other suitable software architectures. In one exemplary embodiment, a software system can include one or more lines of code or other suitable software structures operating in a general purpose software application, such as an operating system, and one or more lines of code or other suitable software structures operating in a specific purpose software application.

E-mail gateway system 802 includes response composition system 804, authorization system 806, and response system 808, each of which can be implemented in hardware, software, or a suitable combination of hardware and software, and which can be one or more software systems operating on a general purpose server platform. E-mail gateway system 802 is coupled to e-mail client 810 through communications medium 822. As used herein, the term “couple”, and its cognate terms such as “couples” and “coupled”, can include a physical connection (such as through a copper conductor), a virtual connection (such as one or more randomly assigned memory locations of a data memory device), a logical connection (such as through one or more logical devices of a semiconducting circuit), a wireless connection, other suitable connections, or a suitable combination of such connections. In one exemplary embodiment, systems and components are coupled to other systems and components through intervening systems and components, such as through an operating system of a general purpose server platform. Communications medium 822 can be a local area network, a wide area network, the public switched telephone network, the Internet, a frame relay, a wireless network, an optical network, other suitable communications media, or a suitable combination of such communications media.

E-mail client 810 can be implemented in hardware, software, or a suitable combination of hardware and software, and can be one or more software systems operating on a general purpose processor platform, a wireless device, a wireless application protocol-(WAP) enabled cell phone, or other suitable devices that can receive and transmit standard e-mail messages. E-mail client 810 transmits an e-mail message to e-mail gateway system 802, such as by generating an e-mail message that includes a functional e-mail address. In this regard, the term “functional” refers to an e-mail address that relates to a functional attribute of e-mail gateway system 802, as opposed to e-mail address to a person that is functioning. A “functional” e-mail address can thus be used to classify e-mails sent to systems of e-mail gateway system 802, whereas a “personal” e-mail address can be used to refer to e-mails that are transmitted and stored in an e-mail mailbox for reading by a user.

E-mail client 810 can include device identification data, such that e-mails transmitted from e-mail client 810 can be identified as coming from a pre-determined device. In this manner, the functional e-mail sent from e-mail client 810 can also include a device identifier as well as a return e-mail address. E-mail gateway system 802 can then verify, such as through authorization system 806, whether the e-mail received from e-mail client 810 has come from a device that has been registered as belonging to the user associated with the e-mail address. Thus, authorization system 806 can receive the device identifier associated with e-mail client 810 and the e-mail address associated with e-mail client 810, and can determine whether the device is an authorized device. Likewise, authorization system 806 can perform other suitable authorization functions, such as by locating pre-determined key words, user IDs, passwords, or other suitable data fields in the e-mail message transmitted from e-mail client 810. In one exemplary embodiment, the e-mail message transmitted from e-mail client 810 can include a password and user ID in the subject line, in the text of the message, following the words “PASSWORD,” “USER ID,” or other suitable words, or can otherwise locate password and user ID data in the message transmitted from e-mail client 810. Authorization system 806 can further generate confirmatory e-mail messages and transmit these confirmatory e-mail messages to an e-mail address of record. In this manner, if a third party has replaced or simulated another user's device identification number and e-mail address, such as to purchase an item, then authorization system 806 can transmit a confirmatory e-mail message to the actual user, which the third party will not intercept. In this manner, authorization system 806 can perform round trip e-mail authorization to provide an added level of security. Authorization system 806 thus can provide multiple levels of authorization security, as suitable for a predetermined level of database access or function.

In another exemplary embodiment, authorization system 806 can be accessed by a user of e-mail client 810, such as through a web browser system operating on e-mail client 810 or other suitable platforms. The user can then provide additional device identifiers for authorized access for some or all functions within the user's account, or other suitable functionality can be provided. Thus, if a user is accessing e-mail gateway system 802 through an e-mail client 810 operating on a device that the user has not authorized, additional authorization functions can be provided to allow the user to temporarily or permanently authorize that device. In one exemplary embodiment, a second set of password and user ID can be used in such situations to authorize temporary or permanent access through a new device. Likewise, voice recognition systems or other suitable systems can be used to provide access through devices that have not been previously authorized.

Response system 808 and response composition system 804 can generate response messages to e-mail messages received from e-mail client 810. If the incoming e-mail message from e-mail client 810 can be responded to without composition of a response, response system 808 generates the response e-mail message. In one exemplary embodiment, if the incoming e-mail from e-mail client 810 is not formatted properly, is not authorized, or has other problems, response system 808 can generate an automatic response identifying the problems with the incoming e-mail message. Likewise, response system 808 can track the state of communications from e-mail client 810, such that the context of data fields submitted in reply messages from e-mail client 810 to response messages from response system 808 can be determined.

In another exemplary embodiment, the state of reply messages can be determined by using forwarding addresses. In this exemplary embodiment, an initial message could be sent to a first functional e-mail address, such as movies@address.com, calendar@address.com, mail@address.com, or other suitable e-mail addresses. Additional functional processes could then be performed by forwarding the response e-mail message from response system 808 to other related functional e-mail addresses. In this exemplary embodiment, for the initial functional e-mail address of movies@address.com, subsequent functions could be performed by forwarding the e-mail message to showtimes@address.com, theaters@address.com, buytickets@address.com, or other suitable functional e-mail addresses. Likewise, these functions could also be performed by replying in a suitable manner to the response message received from response system 808, such as by responding with the message that includes the first key word showtimes in the subject like or body of the e-mail message, or theaters, or purchase or other suitable key words. In this manner, response system 808 can either keep track of state, recognize key words, use functional e-mail addresses, or use other suitable processes to allow user to perform functions and access data through e-mail gateway system 802.

Response composition system 804 receives the incoming e-mail message from e-mail client 810 and composes a response e-mail message. In one exemplary embodiment, response composition system 804 can interact with one or more external systems, such as calendar system 812, external e-mail system 814, contacts management system 816, movie system 818, and sales system 820, and can compile data from such external systems into an e-mail response format that allows the user of e-mail client 810 to request additional data or perform additional functions in reply to the response e-mail. Response composition system 804 can compile data retrieved from databases at one or more related systems into a single e-mail message, such that each responsive data entry is included in the body of the e-mail message. Response composition system 804 can likewise identify such responsive database entries by a number, and can include a suitable instruction to the user of e-mail client 810, such as to reply to the response message by indicating the numbers of the items that the user wishes to see additional information on as the first text string in the reply message. Response composition system 804 can also provide other suitable instructions to the user of the e-mail client 810, so as to allow the user to reply to response messages to perform additional functions or see additional data.

In another exemplary embodiment, response composition system 804 can provide the user of e-mail client 810 with one or more functional e-mail addresses and instructions for the users to forward e-mail to a suitable functional address in order to perform additional functions, such as see additional data, accessing other databases, or otherwise interacting with e-mail gateway system 802. In yet another exemplary embodiment, response composition system 804 can identify commands that the user can include in predetermined fields of the reply e-mail message, such as the subject line, the body of the text as an attachment, or other suitable instructions. In this manner, response composition system 804 provides a standard framework for accessing databases or functionality of external systems via e-mail messaging that allows users to access predetermined data or functions without requiring them to have a user interface system, web browser, client system, or other similar systems that may be required to interface with such external systems.

Calendar system 812, external e-mail system 814, contacts management system 816, movie system 818, and sales system 820 can each be implemented in software, hardware, or a suitable combination of hardware and software, and can be separate software systems operating on separate general purpose server platforms. Likewise, certain of these systems can be related, such as calendar system 812, external e-mail system 814, contacts management system 816, which can be enterprise systems operating on an enterprise network, whereas movie system 818 and sales system 820 can be systems operating on a general purpose server platform of a movie theater enterprise. Other suitable systems or functions can also be provided. Each of these systems can interface with response composition system 804 to provide data fields and functionality in response to incoming e-mail messages from e-mail client 810 that have been processed by response composition system 804. In this manner, e-mail gateway system 802 functions as a fire wall to data and functions hosted on calendar system 812, external e-mail system 814, contact management system 816, movie system 818, sales system 820, and other suitable systems.

Calendar system 812 includes calendar data for one or more users. In one exemplary embodiment, calendar system can be implemented as Microsoft Outlook™, Lotus Notes™, or other suitable software systems that are used to track daily activities and calendar events for one or more users. Calendar system 812 can receive user identification data and field selection data from response composition system 804, and can provide database field entries corresponding to that user identification. In one exemplary embodiment, calendar system 812 can include a database storing information in accordance with a pre-determined database schema or architecture, such as where database entries are organized according to year, month, day, time of day, special events, recurring meetings, or other suitable classifications. In this manner, a user of e-mail client 810 can transmit an incoming e-mail message to response composition system 804 requesting access to that user's data stored on calendar system 812, and can receive in response the available datafields for that user or other suitable combinations of such data. For example, the user can initially send in an incoming e-mail to response composition system 804, such as by addressing the e-mail to calendar@address.com, and can include the word “April” or other suitable month names in the subject line. Response composition system 804 can then access calendar system 812 to obtain a listing of all of that user's calendar entries for the month of April. Response composition system 804 can then provide a response e-mail message that includes the text for each of those April calendar entries, a list of the title of each April calendar entry with an associated number, such that the user can obtain additional data for an entry by replying to or forwarding the response e-mail message and including the associated number in the subject or as initial text in the message, or other suitable functions can be performed. In this manner, the user of e-mail client 810 can access calendar system 812 through e-mail gateway system 802, without having to log on to calendar system 812, operate a thin client, or otherwise interface directly with calendar system 812. Response composition system 804 can also interact with calendar system 812 to perform functions, such as to allow the user of e-mail client 810 to create, modify, or delete an entry for calendar system 812, or perform other suitable functions.

External e-mail system 814 can be a suitable external e-mail system that is not directly accessible through e-mail client 810. In one exemplary embodiment, external e-mail system 814 can include a corporate or enterprise e-mail system, Internet access to e-mail system where the e-mail server for e-mail client 810 will not allow the operator of e-mail client 810 to log on to the external e-mail system 814 due to security settings, or other suitable external e-mail systems. External e-mail system 814 interacts with response composition system 804 to allow a user e-mail client 810 to access e-mails stored on external e-mail system 814. Thus, the incoming e-mail generated by e-mail client 810 can include information such as a user id and password or other suitable data that identifies the user account on external e-mail system 814. The initial query to external e-mail system 814 through e-mail gateway system 802 can also include a key word identifying a folder, addressee, date, or other suitable classification data or e-mail messages stored on e-mail system 814.

In another exemplary embodiment, the incoming e-mail message generated by e-mail client 810 can include the user name and password for access to external e-mail system 814 through e-mail gateway system 802 (likewise, such information can be stored and cross-referenced to the device identification number of the device operating e-mail client 810, or other suitable processes can be used), and the user can also include a key word in the subject line of the e-mail message, such as a folder name (such as “DRAFTS,” “DELETED ITEMS,” “IN-BOX,” in-box folder names, “SENT ITEMS,” “READ,” “UNREAD,” or other suitable folder names), the name of a sender for e-mail messages, a date indicating that the user wishes to receive all e-mail messages that were received on that date, or other suitable data fields. Response composition system 804 can then extract e-mail messages matching the selection criteria from external e-mail system 814, and can combine them into a single message, compose a list with the subject field and an associate number for each e-mail message, or perform other suitable functions.

Response composition system 804 can also interact with external e-mail system 814 to perform functions, such as to allow the user of e-mail client 810 to compose an e-mail message so that it will appear to have been sent by or through external e-mail system 814, to reply to e-mail messages received at external e-mail system 814, to store attachments to a database that is accessible only through external e-mail system 814, delete an e-mail message, or perform other suitable functions.

Contacts management system 816 can be implemented as Microsoft Outlook™, Lotus Notes™, or other suitable systems that allow a user to store contact names, addresses, phone numbers, e-mail addresses, or other suitable contacts information, to sort contacts according to organization, function or other suitable categories, and perform other suitable functions. Thus, the incoming e-mail message generated by e-mail client 810 can include a functional e-mail address such as contacts@address.com which identifies that access to contact management system 816 is requested. Likewise, the user can include a key word, such as an organization name, “PHONE NUMBER” (to see a list of phone numbers), “E-MAIL ADDRESS” (to see a list of e-mail addresses), or other suitable information, or can be prompted by response composition system 804 in a response e-mail message to reply with such key words, to forward a reply to a functional e-mail address, or to reply other suitable manners. Thus, the user of e-mail client 810 can access the data stored by contacts management system 816, and can perform functions with contacts management system 816.

In one exemplary embodiment, a user can send an e-mail to contacts@address.com and can include in the subject line the name of a company. Response composition system 804 can then interact with contacts management system 816 to extract contacts data for that company that is stored in contacts management system 816 for that user, and can compose a response e-mail message that lists all contacts, provides a list with associated numbers for each contact whereby the user can reply or forward an e-mail with list number selections for additional detail, or can perform other suitable functions. Likewise, if contacts management system 816 allows the user to enter new contacts, delete contacts, revise contacts, send e-mail or fax messages, or perform other functions, these functions can be enabled through response composition system 804.

Movie system 818 allows the user to access movie data, such as the titles of movies that are playing, the theaters at which such movies are playing, showtime data, whether or not the seats for a pre-determined showtime have been sold out, and other suitable movie data. Movie system 818 can interface with response composition system 804 to allow user e-mail client 810 to access the data stored in movie system 818. In one exemplary embodiment, the user of e-mail client 810 can send an e-mail to a functional e-mail address such as movies@address.com, which can be processed by response composition system 804 to obtain a listing of movies that are playing through a movie system 818. In this exemplary embodiment, the initial incoming e-mail message from the user at e-mail client 810 can include a keyword request (such as a movie name, a show time, a zip code or city name, a street address or intersection, or other suitable data), and response composition system 804 can interact with movie system 818 to obtain a listing of movies related to that keyword request. Response composition system 804 thus allows a user of e-mail client 810 to interact with movie system 818 in a suitable manner to determine what movies are playing in a location, what the showtimes are, and to otherwise access data stored on movie system 818.

Movie system 818 and sales system 820 can be configured to operate in conjunction with each other such that the user of e-mail client 810 can purchase movie tickets through sales system 820. In one exemplary embodiment, response composition system 804 and mavie system 818 can be used to locate or identify a particular movie at a particular theater at a particular time, and then the user of e-mail client 810 can then submit an e-mail request to purchase tickets for the movie playing at that theater and time. The user of e-mail client 810 can then provide functional data to authorize sales to sales system 820, such as by providing a password and user ID, performing authorization functions, providing a credit card number, or performing other suitable functions. Sales system 820 can interact with movie system 818 and e-mail gateway system 802 to complete the sale, such as by retrieving a credit card number from a database that is associated with that user, validating credit card data provided through e-mail client 810, transferring funds from a bank account or performing other suitable sales confirmation processes. In this manner, sales system 820 can be used to allow movie system 818 or other suitable systems to perform sales activities through e-mail gateway system 802.

In addition, sales system 820 can be used to allow users of e-mail client 810 to perform sales of merchandise or services through e-mail messaging. In one exemplary embodiment, sales system 820 can provide a list of available merchandise or services, and the user of e-mail client 810 can access the list through e-mail gateway system 802, such as by requesting a listing of items in certain categories, a listing of categories, or other suitable classification data. Thus, sales system 820 can be used to allow a user to purchase items through e-mail gateway system 802. In this exemplary embodiment, the user of e-mail client 810 can purchase take-out food (such as by transmitting a reply e-mail or forwarding an e-mail with a selection from a menu provided by sales system 820), purchase airplane tickets (such as by transmitting a reply e-mail or forwarding an e-mail with a selection from a flight list provided by sales system 820), pay a toll (such as by transmitting a reply e-mail or forwarding an e-mail with a toll booth number to sales system 820), purchase vended items (such as by transmitting a reply e-mail or forwarding an e-mail with a selection identifier and vending machine number to sales system 820), or can perform other suitable functions so as to complete sales through sales system 820.

In operation, system 800 allows the user to access data and system functions through e-mail messaging. E-mail gateway system 802 acts as a firewall to receive requests for functions or data from a user in an e-mail format, and then to interface with one or more systems to provide the requested data or functions. In this manner, system 800 allows a user with an e-mail client to access other systems that may not be compatible with the security or processing capabilities of the user's processing platform Thus, a user can access information or functionality of a system without requiring a local client application for that system or other similar functionality that may otherwise be required to access the system.

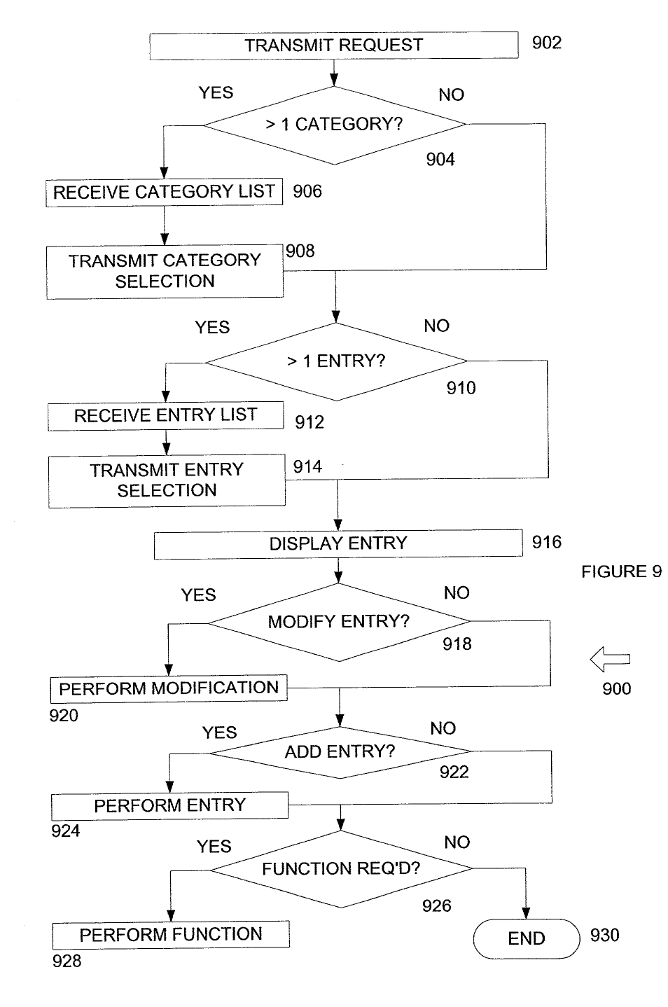

FIG. 9 is a flow chart of a method 900 for providing access to data and system functions by e-mail in accordance with an exemplary embodiment of the present invention. Method 900 can be used to allow an e-mail gateway system or other suitable systems to provide access to system data or functions through e-mail messaging.

Method 900 begins at 902 where a request is transmitted, such as an outgoing e-mail sent to an e-mail gateway system or other suitable request. The request can include one or more pre-determined fields that identify the type of data or function being requested, such as a functional e-mail address, pre-determined data fields within the e-mail message, a device identifier on which an e-mail client 810 is operating, or other suitable data. The method then proceeds to 904.

At 904 it is determined whether there is more than one category for the information or function being requested. In one exemplary embodiment, the category can include one or more months or years in a calendar system, one or more folders in an e-mail system, one or more names or companies in a contact system, one or more theaters or movie titles or other suitable data in the movie system, or other suitable categories. If it is determined that there is not more than one category available the method proceeds directly to 910. Otherwise, the method proceeds to 906 where a category list is received. In one exemplary embodiment, the category list can be generated if the number of entries within all categories exceeds a predetermined size, such that all entries are provided regardless of the number of categories if the number of entries is less than the predetermined size. In another exemplary embodiment, the category list can be generated even if all categories have no entry, such as to allow a user to select a category for entry of data or to perform other functions. The method then proceeds to 908.

At 908 a category selection is transmitted, such as by transmitting one or more associated numbers that are provided with each category and the text or subject of the e-mail message. In this exemplary embodiment, if a user transmits the request for calendar information, they can receive a default list of available months for the current year, such as:

1—April

2—May

3—June;

and so on. The user can then reply to the e-mail message response by including the number of the month of interest, such as “1.” In this manner, the user can request all entries for the month, a pre-determined month, or other suitable categories. The method then proceeds to 910.

At 910 it is determined whether there is more than one entry for the category selected. In one exemplary embodiment, if the total amount of text required to provide information on all entries is less than a pre-determined amount, data for all entries can be provided. Likewise, if there is only one entry then that one entry can also be provided. If it is determined at 910 that there is not more than one entry the method proceeds to 916. Otherwise, the method proceeds to 912 where an entry list is received by the user. The method then proceeds 914 where the user can select one or more selections from the entry list in order to obtain the detailed data for those entries. The method then proceeds to 916.

At 916 the one or more entries selected are displayed, such as by receiving a response e-mail message that includes in the body of the e-mail message each of the entries. The method then proceeds to 918 where it is determined whether or not a request has been received to modify an entry. In one exemplary embodiment, an entry such as a calendar entry or a contact entry can be modified, such as to add additional detail, phone numbers, or for other suitable purposes. If it is determined at 981 that no modification is required, the method then proceeds to 922. Otherwise the method proceeds to 920 where a modification process is performed, such as by receiving field identifiers and modification data, a request for available modification fields, or other suitable data. The method then proceeds to 922.

At 922 it is determined whether a new entry is to be added. If a new entry is not to be added the method proceeds to 926, otherwise the method proceeds to 924 where the new entry is performed. In one exemplary embodiment, the entry can be performed by providing instructions to reply or forward the e-mail to a functional address or perform other suitable functions, by exchanging one or more response e-mails that prompt the users to provide other entry data fields, or by other suitable processes. The method then proceeds to 926.

At 926 it is determined whether a function has been requested. In one exemplary embodiment, the function can include purchasing an item, sending an e-mail, deleting an entry, or other suitable functions. If it is determined at 926 that a function has been requested, then the method proceeds to 928 where the function is performed. Otherwise the method proceeds to 930 and terminates.

In operation, method 900 allows the user to access data from a suitable system, such as a calendar system, an external e-mail system, a contacts management system, a movie system, or other suitable data systems, and to modify the data, add new entries, perform functions, or take other suitable actions, through the use of e-mail messaging. Method 900 thus allows users of an e-mail client to access databases and perform other suitable functions without a client application, local application, or other suitable systems or functionality that would otherwise be required to directly interface with the system.

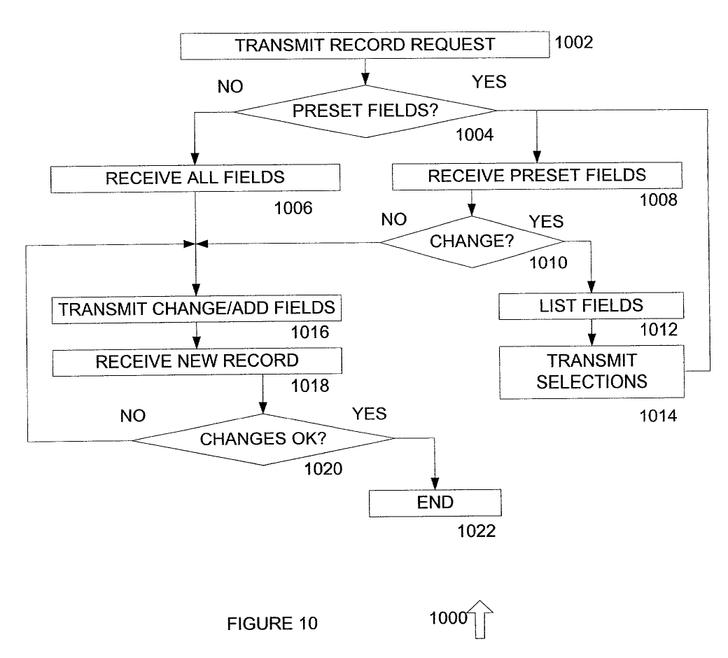

FIG. 10 is a flow chart of a method 1000 for adding or modifying records in accordance with exemplary embodiment of the present invention. Method 1000 allows the user to add or modify records in a database using e-mail messaging, such that the user does not require database access software to be operating on the platform that the user is operating.

Method 1000 begins at 1002 where a record is transmitted in response to a request. The record can include data fields that have been stored for the record, such as where the record is going to be modified, or available data fields for the record, such as where the record is going to be added. The method then proceeds to 1004, where it is determined whether pre-set fields have been identified for the record. If pre-set fields have not been identified, the method proceeds to 1006 where the user receives all of the fields for the record. Otherwise, the method proceeds to 1008 where the user receives the pre-set fields. The method then proceeds 1010 where it is determined whether the user wishes to change the pre-set fields, such as to receive new fields for all requested records in the future, for this record, or in other suitable circumstances. If the user does not wish to change the pre-set fields, the method proceeds to 1016. Otherwise the method proceeds to 1012 where the available fields are listed. Likewise, if the user knows the names of the fields that the user requires, the user can include those field identifiers with the request for a change at 1010 instead of selecting from the list. The method then proceeds 1014 where the field preset selection requests are transmitted to the database, such as through an e-mail gateway system or other suitable systems. The method then returns to 1008 where the user receives the new pre-set fields.

After the user has received all fields at 1006 or all fields of interest at 1008, the method proceeds to 1016 where change fields or add fields are transmitted. In one exemplary embodiment, the user can provide field identifiers and modification data in reply to a response e-mail message that includes the pre-set or all data fields. In this exemplary embodiment, the user can include the change fields as the initial text in the reply message, can put the changed text in parentheses following the old text, can include a key word such as “NEW” or other suitable key words with data field identifiers, or can perform other suitable functions. Likewise, if the user wishes to enter a new record without accessing existing records, the record request transmitted at 1002 can include a request for all data fields that can be provided for a new entry, such that the pre-set or all fields received at 1008 and 1006 are the field identifiers, and where the field entry data is provided at 1016. The method then proceeds to 1018.

At 1018 the new or modified records is received, such that the user can verify that the changes requested have been incorporated properly. The method then proceeds to 1020 where it is determined whether the user has accepted the changes. If the user accepts the changes the method proceeds to 1022 and terminates. Otherwise the method returns to 1016 where the user can transmit new changes or modifications.

In operation, method 1000 allows a user to modify or add new records in a database through the use of an e-mail transmitted request. Method 1000 can be used in conjunction with an e-mail gateway system or other suitable systems to allow a user to access data without requiring the user to have a data access client or other suitable software applications operating on the users processing platform, such that the user only requires an e-mail client or other suitable e-mail systems to allow the user to access one or more other applications.

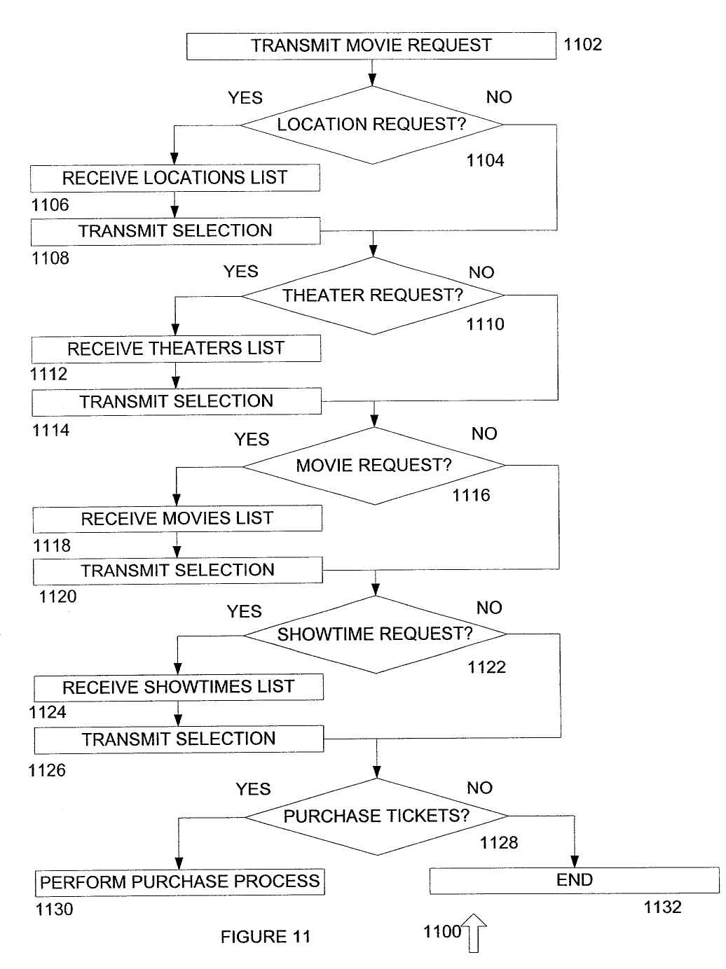

FIG. 11 is a flow chart of a method 1100 for accessing movie data and purchasing tickets in accordance with an exemplary embodiment of the present invention.

Method 1100 allows movie data and ticket purchases to be made by e-mail, such that access to a web browser or others similar devices it not required.

Method 1100 begins at 1102 where a movie request is transmitted. In one exemplary embodiment, the movie request can be included within an e-mail message to a functional movie address, such as movies@address.com. The user can then receive a response to the movie request that identifies one or more fields, such as location, theater, movie, or showtime, that the user can provide to receive additional information. Likewise, the user can provide such information in the initial movie request, such as by transmitting an e-mail to movies@address.com that includes location data (such as a city name, zip code, or nearest intersection) a showtime, a movie title, or other suitable data.

At 1104 it is determined whether a location request has been received. In one exemplary embodiment, location requests can be received by replying to instructions received in the response after the initial transmission for request for movie information, can be received by including location request data with the initial incoming e-mail, or other suitable location request processes can be used. If it is determined at 1104 that a location request has not been received, the method proceeds to 1110. Otherwise, the method proceeds to 1106 where a list of locations is received. In one exemplary embodiment, the list of locations can be a list of cities, areas within the cities such as suburbs, or other suitable locations. The method then proceeds to 1108 where a selection from the location list is transmitted, such as by transmitting a reply e-mail with a number associated with a location, the name of the location, forwarding such messages to a suitable functional e-mail address, or other suitable selections. The method then proceeds to 1110.

At 1110 it is determined whether a request for available theaters has been received, such as with the initial incoming e-mail request, in response to the incoming e-mail request to provide additional information such as a theater, or other suitable matters. If a theater request has not been received at 1110, the method proceeds to 1116. Otherwise, the method proceeds to 1112 where a list of theaters is received. The list of theaters can include theaters in a predetermined location (such as by including location data with the request), theaters having a predetermined movie (such as by including movie identification data with the request), theaters having movies at a predetermined showtime (such as by including showtime data with the request), or other suitable theaters. The method then proceeds to 1114 where a selection is transmitted from the theater list. The method then proceeds to 1116.

At 1116 it is determined whether a movie request has been received, such as by transmitting a request for available movies with the initial incoming e-mail, in response to selection criteria, or other suitable movie requests. If no request for movies has been received, the method then proceeds to 1122. Otherwise, the method proceeds to 1118 where a list of available movies is received. The list of movies can include movies in a predetermined location (such as by including location data with the request), movies at a predetermined theater (such as by including theater identification data with the request), movies having a predetermined showtime (such as by including showtime data with the request), or other suitable movies. The method then proceeds to 1120 where the user transmits a selection from the list, such as by listing an associated number, providing a title information, or other suitable selection data. The method then proceeds to 1122.

At 1122 it is determined whether a request for showtime data has been received. If a request for showtime data has not been received, the method proceeds to 1128. Otherwise, the method proceeds to 1124 where a list of available showtimes is provided. The list of showtimes can include showtimes for a predetermined location (such as by including location data with the request), showtimes at a predetermined theater (such as by including theater identification data with the request), showtimes for a predetermined movie (such as by including a movie identifier with the request), or other suitable showtimes. The method then proceeds to 1126 where a selection from the list is transmitted. The method then proceeds to 1128.

At 1128 it is determined whether a request to purchase tickets has been transmitted. If no request for purchasing tickets has been transmitted, the method proceeds to 1132. Otherwise, the method proceeds to 1130 where a ticket purchase process is performed. In one exemplary embodiment, the ticket purchase process can be performed for seats to a movie and at a theater and showtime that have been identified by performing the steps of method 1100 as shown, in other suitable sequences, or in other suitable manners.

In operation, method 1100 shows an exemplary process by which e-mail can be used to identify movies and to allow a user to select a movie showtime, title, and theater at which the user wishes to purchase tickets. Method 1100 thus allows users to determine available movies and showtimes and theater locations by e-mail without requiring the user to have access to a web browser or other suitable device.

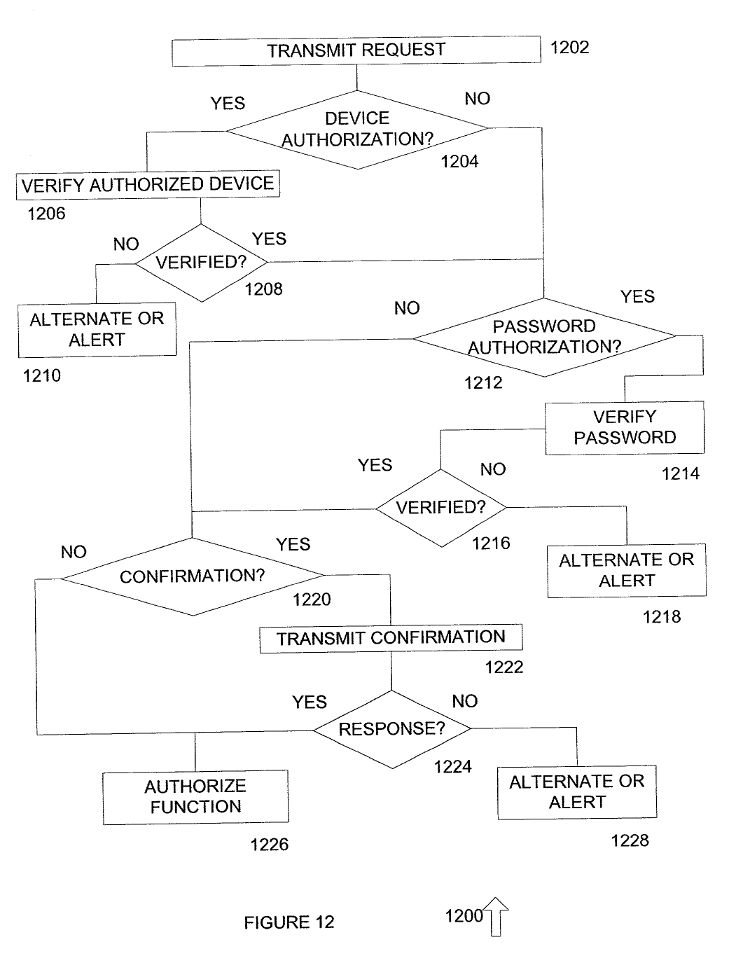

FIG. 12 is a flowchart of a method 1200 that allows a user having e-mail access to a database or functions to be authorized for such access or function performance in accordance with an exemplary embodiment of the present invention.

Method 1200 begins at 1202 where a request is transmitted, such as an incoming e-mail message from an e-mail client operating on a device. The method then proceeds to 1204 where it is determined whether device level authorization is being used. If it is determined that device authorization is not being used the method proceeds to 1212. Otherwise, the method proceeds to 1216 where it is verified whether an authorized device is being used. The authorized device can be a device that has a device identifier that is stored in a database, that is associated with the e-mail address that the e-mail is being received from, or other suitable authorized devices. The method then proceeds to 1208.

At 1208 it is determined whether the authorized device has been verified. If the authorized device has not been verified the method proceeds to 1210 where an alternate process or alert is performed. In one exemplary embodiment, the alternate process can allow a user to add an authorized device, such as by transmitting an authorized device password, using voice identification, or other suitable processes. Likewise, if the device is not authorized then an alert can be generated, transmitted to the user at an e-mail address of record indicating that someone at an unauthorized device was attempting to access the user's data, or transmitted to other suitable locations. If it is determined at 1208 that the device has been authorized and the device has been verified, the method then proceeds to 1212.

At 1212 it is determined whether password authorization is being used. If password authorization is not being used, the method proceeds to 1220. Otherwise the method proceeds to 1214 where the password is verified, such as by determining whether a user ID and password provided with the request match the user ID and password stored for that user, authorized device, or other suitable criteria. The method then proceeds to 1216.

At 1216 it is determined whether the password has been verified. If the password has been verified the method proceeds to 1220. Otherwise the method proceeds to 1218 where an alternative process or alert is performed. In one exemplary embodiment, if the user has attempted to provide a password and user ID one or more times and has failed, then user can be provided with the option of requesting that the forgotten password be transmitted to an address of record. Likewise, an alert can be generated or suitable processes can be performed.

At 1220 it is determined whether an e-mail confirmation process is being used. If an e-mail confirmation is not being used the method proceeds to 1226. Otherwise, the method proceeds to 1222 where a confirmation e-mail is transmitted. In one exemplary embodiment, the confirmation e-mail can be transmitted to an e-mail address of record, such that a third party that has modified the device identification data and password or user ID data of their device so as to masquerade as an authorized user will be precluded from responding to the confirmation e-mail. The method then proceeds to 1224 where it is determined whether a response to the confirmation e-mail has been received. No response has been received the method proceeds to 1228 where an alternative process or alert is performed. Otherwise the method proceeds to 1226 where the function is authorized, such as a purchase, database modification, access to data having a higher level of security, or other suitable functions.

In operation, method 1200 allows a user to access a database, functions, or other suitable processes while controlling such access through one or more levels of authorization security. Method 1200 can be performed at an initial access point, such as logon, can be performed in stages where the device authorization, password authorization, or confirmation processes are used following the performance of one or more prior functions (such as to add or delete data), or can otherwise be used to ensure that only authorized users are allowed to access data and perform functions, such as purchasing goods or services, modifying data stored in databases, or other suitable functions.

Although the invention is preferably described herein with reference to the exemplary embodiments shown herein, one skilled in the art will readily appreciate that other architectures may be substituted for those set forth herein without departing from the spirit and scope of the present invention. Accordingly, the invention should only be limited by the claims included below.

What is claimed is:

1. An e-mail access gateway system comprising:
an authorization system receiving an e-mail message and determining whether a reply to the e-mail message is authorized; and
a reply system receiving the e-mail message and generating a response message if the e-mail message is authorized.

2. The system of claim 1 further comprising a reply composition system coupled to the reply system, the reply composition system receiving the e-mail message, extracting one or more query data fields, and assembling the response message from one or more response data fields that are selected in response to the one or more query data fields.

3. The system of claim 1 further comprising an e-mail system coupled to the reply system, the e-mail system providing one or more external e-mail messages to the reply system, and the reply system incorporating one or more fields from the one or more external e-mail messages into the response message.

4. The system of claim 1 further comprising a contacts management system coupled to the reply system, the contacts management system providing one or more fields to the reply system, and the reply system incorporating one or more fields from the contacts management system into the response message.

5. The system of claim 1 further comprising a calendar system coupled to the reply system, the calendar system providing one or more fields to the reply system, and the reply system incorporating one or more fields from the calendar system into the response message.

6. The system of claim 1 further comprising a movie system coupled to the reply system, the movie system providing one or more fields to the reply system, and the reply system incorporating one or more fields from the movie system into the response message.

7. The system of claim 1 further comprising a sales system coupled to the reply system, the sales system extracting purchase request data from the e-mail message and generating sales authorization data.

8. A method for allowing a user to access data using e-mail comprising:
transmitting an e-mail message containing authorization data to a gateway system;
receiving response data from the gateway system if the authorization data is correct; and
receiving a general message from the gateway system if the authorization data is incorrect.

9. The method of claim 8 wherein the general message is an error message.

10. The method of claim 8 wherein transmitting the e-mail message containing the authorization data to the gateway system comprises transmitting the e-mail message to a functional e-mail address.

11. The method of claim 8 wherein transmitting the e-mail message containing the authorization data to the gateway system comprises transmitting the e-mail message containing an authorized device identifier.

12. The method of claim 8 wherein transmitting the e-mail message containing the authorization data to the gateway system comprises transmitting the e-mail message containing an authorized username field and password field.

13. The method of claim 8 wherein transmitting the e-mail message containing the authorization data to the gateway system further comprises:
receiving a record address message from the gateway system addressed to a record address; and
replying to the record address message.

14. The method of claim 8 further comprising:
replying to the response data with one or more reply data fields; and
receiving supplemental response data in response to the reply data fields.

15. The method of claim 8 wherein the e-mail message includes an external e-mail account identifier and the response data includes one or more external e-mail account messages.

16. The method of claim 8 wherein the e-mail message includes a calendar identifier and the response data includes one or more calendar data fields.

17. The method of claim 8 wherein the e-mail message includes a contacts identifier and the response data includes one or more contacts data fields.

18. A method for receiving movie data using e-mail comprising:
transmitting movie request data to a functional e-mail address; and
receiving one or more movie data fields in response to the movie request data.

19. The method of claim 18 wherein transmitting movie request data includes transmitting one or more of the group comprising location data, theater data, title data, and showtime data.

20. The method of claim 18 wherein receiving the one or more movie data fields in response to the movie request data further comprises:
receiving an e-mail message that includes one or more movie titles and an associated number;
replying to the e-mail message with one or more of the associated numbers; and
receiving an e-mail message that includes one or more showtimes for the movie titles corresponding to the one or more associated numbers.

21. The method of claim 18 further comprising:
transmitting a ticket purchase request in response to the one or more movie data fields; and
receiving purchase confirmation data.
